(19) United States
(12) Patent Application Publication
(10) Pub. No.: US 2009/0186289 A1
(43) Pub. Date: Jul. 23, 2009

(54) TONER, IMAGE FORMATION METHOD AND IMAGE FORMING APPARATUS

(76) Inventors: Minoru NAKAMURA, Mishima-shi (JP); Akira Izutani, Talatsuki-shi (JP); Tsuyoshi Nozaki, Ikeda-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/357,682

(22) Filed: Jan. 22, 2009

(30) Foreign Application Priority Data
Jan. 23, 2008 (JP) 2008-012428

(51) Int. Cl. G03G 9/087; G03G 9/00; G03G 13/20; G03G 15/20

(52) U.S. Cl. 430/108.4; 430/105; 430/109.4; 430/108.8; 430/108.1; 430/124.4; 430/124.13; 399/320

(57) ABSTRACT

A toner including a binder resin, a coloring agent, an infrared absorbing agent having at least a maximum absorption wavelength in a wavelength range of from 700 to 1,100 nm, and a fixed surface protective agent, wherein, for a cross section observation of the toner, the infrared absorbing agent which exists in the vicinity of the fixed surface protective agent occupies at least 60% by area based on the entire area of the infrared absorbing agent and is present inside the toner closer to the surface of the toner than to the center area thereof.

### BACKGROUND OF THE INVENTION

1. Field of the Invention

The present invention relates to a toner and an image formation method and an image forming apparatus using a development agent including the toner.

2. Discussion of the Background

In general, methods of fixing a toner image on a recording medium upon application of heat are typified into a contact heat fixing system and a non-contact heat fixing system. The non-contact heat fixing system is a fixing system in which no member contacts with a powder toner image during fixing. Major examples thereof include a flash fixing system and an oven (atmosphere) fixing system. In the flash fixing method, a powder toner image transferred from an image bearing member or an intermediate transfer member to a recording medium is irradiated with flash emitted from a light source, for example, a Xenon or halogen flash lamp, to melt the toner by radiation heat, thereby fixing the powder toner image. In the oven fixing method, a powder toner image transferred from an image bearing member or an intermediate transfer member to a recording medium is irradiated with, for example, infrared in an oven atmosphere, to melt the toner by the radiation heat, thereby fixing the powder toner image on the recording medium.

Such a non-contact heat fixing system has the following advantages.

Since no member is brought into contact with a powder toner image to melt the toner, image crushing by a member is avoided so that the image definition at development is maintained.

The fixing time is extremely short, which enables a high speed fixing.

The waiting time ascribable to fixing can be saved so that the first print (copy) output time can be shortened.

Dealing with various kind of recording media, for example, having different thickness or paper quality, is easy.

However, the non-contact heat fixing in the non-contact heat fixing system diffuses energy to the outside environment. On the other hand, reducing the fixing energy is an issue in terms of the environment. However, when the total amount of light energy provided to a powder toner image is short, the powder toner image is not sufficiently melted, which leads to deterioration of the fixing property. In addition, controlling the amount of this energy is difficult especially in the case of full color image formation in which a monochrome color image and a full color image are output because the amount of absorption energy varies depending on colors.

In recent years, the particle diameter of toner has been reduced to improve the quality of images. This size reduction of toner particles sacrifices the print density and the fixing property while the amount of toner attached to a recording medium to secure the printing area is reduced. The deterioration of the fixing property, etc. deriving from the size reduction of toner particles is significant in the non-contact heat fixing system in comparison with the contact heat fixing system in which toner is melted by a pressure roller and a heating roller. Furthermore, although the fixing property is desirable for an image such as a solid image having a large amount of attached toner but deteriorates when a toner image such as a character image or a half tone image having a relatively small amount of attached toner is fixed. In addition, this problem is significant for a half tone image in comparison with a character image when the amount of the attached toner is in the same quantity.

When the amount of the energy of a fixing device increases to improve the fixing property, the energy is excessively absorbed at black toner portions, which causes a bumping phenomenon and thus image noise. Additionally, when a recording medium having a fixed image on one side thereof is abraded by a roller, etc. in a paper path, toner bleed and smear, etc. easily occur so that the quality of images deteriorates due to deterioration of anti-smear property.

Also, size reduction of an image forming apparatus is demanded in terms of space saving and a free latitude of installation thereof. This trend is significant for a printer using a single component development device, which is advantageous with regard to the size reduction. To deal with such size reduction of an apparatus, each part thereof is required to be small. This is true in the toner conveyer mechanism in the development device of an image forming apparatus, thereby creating a problem. As the diameter of a development roller which transfers toner to an image bearing member and the diameter of a supplying roller which supplies the toner to the development roller decrease, the number or rotation and the stress on the toner increase. Thus, the toner component transfers to a regulating blade, resulting in occurrence of fixation thereon. The deterioration about fixation ascribable to the size reduction of the diameter of a development roller is significant in a toner having a small particle diameter and more significant when such a toner includes a releasing agent such as wax.

Unexamined published Japanese patent application No. (hereinafter referred to as JOP) 2006-78899 describes a method of manufacturing a color toner for optical fixing and a non-visible toner as a technology to solve this problem. The method includes a process of manufacturing a master batch including an infrared absorbing agent which is dispersed in a component containing a binder resin and/or a wax in such a manner that the density of the infrared absorbing agent is from 20 to 80% by weight; a process of manufacturing a toner composition containing the infrared absorbing agent having a desired density by mixing the master batch with other toner component; and a process of mixing and kneading the toner composition followed by cooling down and pulverization to obtain toner particles. Thereby, the infrared absorption agent is optimally dispersed in the toner composition containing the binder resin, the coloring agent, a charge control agent, etc. In addition, the toner has a high infrared absorbing power with a good optical fixing property and reading property on non-visible images (transparent toner). Furthermore, technologies for economical methods of manufacturing color toner and non-visible (transparent) toner for optical fixing are described.

In addition, JOP 2003-156881 describes a flash fixing toner which contains at least a binder resin, a coloring agent, a wax component and an infrared absorbing agent which has a maximum absorption wavelength in the wavelength range of from 750 to 1,100 nm. In the toner, the infrared absorbing agent is dissolved in the wax and the addition amount of the infrared absorbing agent is set to be from 0.1 to 2% by weight to have a good flash fixing property and a stable charging property. Furthermore, this flash fixing toner can be economically manufactured.

However, when such a toner has a relatively small particle diameter and is used as a single component development agent in a full color image forming apparatus, securing anti-smear property and prevention of fixation are difficult, which leads to a problem of deterioration of the quality of produced images.

Furthermore, JOP 2004-157157 describes a toner which has a good fixing property and anti-smear property by having the maximum absorbency in the wavelength range of from 810 to 870 nm which is at least twice the maximum absorbency in the wavelength range of from 870 to 1,000 nm. However, when the amount of the infrared absorbing agent is reduced, the effect extremely drops so that securing anti-smear property and prevention of fixation are difficult, which leads to a problem of deterioration of the quality of produced images.

### SUMMARY OF THE INVENTION

Because of these reasons, the present inventors recognize that a need exists for a toner which stably has a toner developing property regardless of the consumption amount of the toner and a good anti-smear property in a non-contact fixing process, is free from vertical streaks or uneven density in an image on a recording medium after fixing and is suitable for dealing with various kinds of media from thin media to thick media to rough media and brimless images and an image formation method and an image forming apparatus using the toner.

Accordingly, an object of the present invention is to provide a toner which stably has a toner developing property regardless of the consumption amount of the toner and a good anti-smear property in a non-contact fixing, is free from vertical streaks or uneven density in an image on a recording medium after fixing and is suitable for dealing with various kinds of media from thin media to thick media to rough media and brimless images and an image formation method and an image forming apparatus using the toner.

Briefly this object and other objects of the present invention as hereinafter described will become more readily apparent and can be attained, either individually or in combination thereof, by a toner including a binder resin, a coloring agent, an infrared absorbing agent having at least a maximum absorption wavelength in the wavelength range of from 700 to 1,100 nm and a fixed surface protective agent. In the toner, for a cross section observation of the toner, the infrared absorbing agent which exists in the vicinity of the fixed surface protective agent occupies at least 60% by area based on an entire area of the infrared absorbing agent and is present inside the toner closer to the surface of the toner than to the center area thereof.

It is preferred that, in the toner mentioned above, the binder resin includes polyester resin.

It is still further preferred that, in the toner mentioned above, the polyester resin has a glass transition temperature of 40° C. or higher.

It is still further preferred that, in the toner mentioned above, the fixed surface protective agent is at least one compound selected from the group consisting of paraffins, synthetic esters, polyolefins, carnauba wax, and rice wax and the toner includes the fixed surface protective agent in an amount of from 3 to 30% by weight.

It is still further preferred that the toner mentioned above includes the infrared absorbing agent in an amount of 0.01 to 2% by weight.

It is still further preferred that, in the toner mentioned above, at least two compounds having respective maximum absorption wavelengths are used as the infrared absorbing agent.

It is still further preferred that the toner mentioned above has an average circularity of 0.95 or higher.

As another aspect of the present invention, an image formation method is provided which includes charging an image bearing member to bear a latent electrostatic image on the surface thereof, irradiating the surface of the image bearing member to form the latent electrostatic image, developing the latent electrostatic image with a development agent including the toner mentioned above to form a toner image, transferring the toner image to a recording medium and fixing the toner image on the recording medium by a flash fixing mechanism.

It is preferred that, in the image formation method mentioned above, the flash fixing mechanism includes a mechanism which smoothes the surface of the toner of the toner image fixed on the recording medium.

It is still further preferred that, in the image formation method mentioned above, a single component development mechanism is used in the process of developing the latent electrostatic image.

As another aspect of the present invention, an image forming apparatus is provided which includes an image bearing member to bear a latent electrostatic image thereon, a charging device to charge the surface of the image bearing member, an irradiation device to irradiate the surface of the image bearing member to form the latent electrostatic image, a development device including a development unit accommodating a development agent including the toner mentioned above, the development device to develop the latent electrostatic image with the development agent to form a toner image on the surface of the image bearing member, a transfer device to transfer the toner image to a recording medium while contacting the surface of the image bearing member with the recording medium therebetween and a fixing device to flash-fix the toner image on the recording medium.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of the image forming apparatus of the present invention;

FIG. 2 is a schematic diagram illustrating the development device of the image forming apparatus of FIG. 1;

FIG. 3 is a diagram illustrating an example of the non-contact type fixing device related to the present invention;

FIG. 4 is a schematic diagram illustrating an example of a process cartridge; and

FIG. 5 is a schematic diagram illustrating the structure of the present invention.

### DETAILED DESCRIPTION OF THE INVENTION

The present invention will be described below in detail with reference to several embodiments and accompanying drawings.

The toner of the present invention has a binder resin, a coloring agent, an infrared absorbing agent having at least a maximum absorption wavelength in a wavelength range of from 700 to 1,100 nm, and a fixed surface protective agent. In addition, for a cross section observation of the toner, the infrared absorbing agent exists in the vicinity of the fixed surface protective agent in an amount of at least 60% by area based on the entire area of the infrared absorbing agent and is present inside the toner (meaning that the infrared absorbing agent does not expose to the surface of the toner) and closer to the surface of the toner than to the center area thereof.

In the present invention, the toner effectively absorbs optical energy and converts it into thermal energy which is enough to melt toner particles one by one.

When the amount of toner attached is relatively small (for example, when an image having a portion having a low density is formed or the entire amount of toner attached to a solid portion is reduced), for example, 2 g/m² or less, a problem arises that the fixing property deteriorates. This phenomenon is considered to occur because toner particles are isolated on a recording medium and part of radiation heat escapes to the recording medium or outside so that a sufficient amount of the radiation heat is not secured to melt the toner while when toner particles are densely present on a recording medium, for example, around 5 g/m² or less, the heat hardly escapes to the surrounding and is conveyed from toner particles to toner particles, which secures sufficient fixing.

However, in the present invention, toner is sufficiently melted one particle by one particle as described above, the toner penetrates into a recording medium even when the amount of toner attached to the recording medium is reduced or toner particles are isolated from each other on the recording medium. Therefore, the toner is efficiently fixed on a recording medium as a full color toner for non-contact heat fixing. Furthermore, since the infrared absorbing agent is present in the vicinity of the fixed surface protective agent in an amount of 60% or higher, the fixed surface protective agent is melted relatively soon when the optical energy is absorbed and converted into the thermal energy. In addition, since the fixed surface protective agent exists relatively close to the surface of the toner, the fixed surface protective agent easily oozes to the toner surface. The mechanism is considered to be that, when the binder resin and the fixed surface protective agent are melted, the fixed surface protective agent tends to ooze to the surface of the fixed image because the density of the fixed surface protective agent is extremely smaller than that of the binder resin. Therefore, the fixed surface protective agent easily covers the surface of the fixed image, thereby improving the anti-smear property. The toner demonstrates efficient fixing and good anti-smear property for a full color image even with a relatively small fixing energy, for example, 3 to 5 J/cm².

In the present invention, since the infrared absorbing agent and the fixed surface protective agent do not substantially expose to the surface of the toner, the toner component is hardly transferred to a regulating blade in a single component development device so that fixation and filming can be prevented. When the infrared absorbing agent and the fixed surface protective agent expose to the surface of the toner, fixation on a regulation blade tends to occur. Once fixation occurs at the nip portion where the toner is nipped between the regulating blade and the development roller, a convex portion formed by fixated toner dams the toner which is transferred on the development roller and prevents smooth transfer of the toner. Therefore, the transfer amount of the toner which should be used for development decreases, resulting in production of an abnormal image having latitudinal (vertical) streaks. This fixation problem is noticeable in the case of a toner having a small particle diameter and more noticeable when such a toner further contains a fixed surface protective agent such as wax.

The toner of the present invention contains a binder resin, a coloring agent, a fixed surface protective agent, an infrared absorbing agent, etc. An infrared absorbing agent having an absorption wavelength in the range of oscillation wavelength of a light source is selected as the infrared absorbing agent for the toner of the present invention.

The infrared absorbing agent for use in the toner of the present invention has an absorption peak in the wavelength range of from 700 to 1,100 nm.

Specifically, the infrared absorbing agent is selected from the group consisting of a cyanine based compound, a polymethine based compound, an aminium based compound, a diimonium based compound, a phthalocyanine based compound, a merocyanine based compound, a benzenethiol based metal complex, a mercaptophenol based metal complex, an aromatic diamine based metal complex, a nickel complex compound, an anthraquinone based compound, a naphthalocyanine based compound, and an indolenine compound.

In the present invention, among the compounds specified above, using a compound having an absorption peak in the wavelength range of from 800 to 1,000 nm is preferred in terms of efficient optical absorption. More preferably, the toner of the present invention contains at least two compounds having respective maximum absorption wavelengths as the infrared absorbing agent. To be specific, it is more preferred to use at least a compound having an absorption peak in the wavelength range of from 800 to 870 nm and more preferably from 810 to 840 nm in a particularly preferred combination with a compound having an absorption peak in the wavelength range of from 870 to 1, 000 nm and more preferably from 900 to 980 nm.

Specific examples of the compounds having an absorption peak in the wavelength range of from 800 to 870 nm include, but are not limited to, a polymethine based compound (R-820B, manufactured by Nippon Kayaku Co., Ltd.), cyanine based compounds (CY-2, CY-4 and CV-9, manufactured by Nippon Kayaku Co., Ltd.), and an indolenine compound (represented by the Chemical Structure (B).

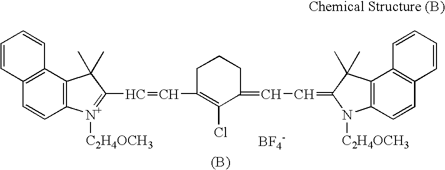

The indolenine compound is preferred in terms that optical energy is effectively absorbed even when the amount of the optical energy is small and the side effect on the color reproducibility for a color toner is small. Since the indolenine compound has a sharp peak in the absorption spectrum thereof, the light in a desired wavelength range can be efficiently absorbed and also the indolenine compound is preferred because the absorption thereby is little in the optical part of the spectrum.

Specific examples of the compounds having an absorption peak in the wavelength range of from 870 to 1,000 nm include, but are not limited to, a diimonium based compound (NIR-AM1 and NIR-IM1 manufactured by Nagase Chemtex Corporation, IRG-022 and IRG-023, manufactured by Nippon Kayaku Co., Ltd.), phthalocyanine based compounds (TX-305A, manufactured by Nippon Shokubai Co., Ltd.), and an aminium based compound (CIR-960 and CIR-961, manufactured by Japan Carlit Co., Ltd., IRG-002, IRG-003 and IRG-003K, manufactured by Nippon Kayaku Co., Ltd., a compound represented by the Chemical Structure (C). The aminium based compound is preferred in terms that optical energy is effectively absorbed even when the amount of the optical energy is small and the side effect on the color reproducibility for a color toner is less.

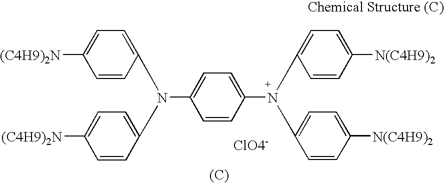

The total addition amount of the infrared absorbing agent is from 0.01 to 2 parts by weight and preferably from 0.1 to 1 part by weight to obtain a good fixing property without having an adverse impact on the color reproducibility, the charging property, the cost, etc. In addition, the ratio of the two kinds of the infrared absorbing agents (the addition amount of the infrared absorbing agent having the maximum absorbency in the wavelength range of from 800 to 870 nm to the addition amount of the infrared absorbing agent having the maximum absorbency in the wavelength range of from 870 to 1,000 nm) is from 1:4 to 4:1 and preferably from 1:3 to 2:1 to improve the fixing property by a small amount of the infrared absorbing agents.

With regard to the toner of the present invention, the infrared absorbing agent present around the fixed surface protective agent occupies at least 60% based on the entire fixed surface protective agent for cross-section observation of the toner and exists close to the surface of the toner rather than the center area thereof but does not expose to the surface of the toner.

The infrared absorbing agent can be contained together with the fixed surface protective agent inside the toner by dissolving or dispersing the infrared absorbing agent in a solvent together with the fixed surface protective agent. Therefore, the infrared absorbing agent is present around the fixed surface protective agent. Thereby, the fixed surface protective agent demonstrates a sufficient fixing surface protection effect when melted by light absorption and prevents deterioration and detachment of the infrared absorption agent and thus no contamination in the development device caused by the detachment occurs. Furthermore, when the compatibility of the infrared absorbing agent and the binder resin is suitably selected considering the compatibility of the binder resin and the fixed surface protective agent, the infrared absorbing agent and the fixed surface protective agent can be contained in the toner close to the surface thereof, which reduces the addition amount of the infrared absorbing agent and the fixed surface protective agent and thus is advantageous in terms of the cost. When a fixed surface protective agent having a low compatibility with a binder resin is selected, the fixed surface protective agent is not present evenly in the toner but locally present around the surface thereof. In addition, when an infrared absorbing agent having a low compatibility with a binder resin is suitably selected, the infrared absorbing agent is also locally present close to the surface of the toner. Thus, the infrared absorbing agent exists only in the area where the fixed surface protective agent are present so that the infrared absorbing agent can demonstrate a sufficient effect in a small amount.

By selecting a non-polar fixed surface protective agent having a low compatibility with a binder resin, the fixed surface protective agent exists close to the surface of the toner. Paraffin wax is preferable as the non-polar fixed surface protective agent when the binder resin is a polyester resin. In addition, by using an infrared absorbing agent having a low polarity and an adequately low compatibility with a binder resin, the infrared absorbing agent is present near the surface of the toner and around the non-polar fixed surface protective agent. Indolenine compounds and aminium compounds are preferable as the infrared absorbing agent having an adequately low compatibility with a polyester based resin.

The compatibility can be determined according to the solubility parameter (SP value), which is an indicator of the molecular polarity of a polymer. The greater the SP value, the stronger the molecular polarity. Compounds having similar SP values have a high affinity. Compounds having SP values away from each other have a low compatibility. For example, the polyester resin has an SP value of 10.9 while the paraffin wax has an SP value of 7.5. In this example, the compatibility of the two is determined as low. Although the SP value of an infrared absorbing agent is not certain, the compatibility of the infrared absorbing agent can be determined in some degree based on the molecular polarity of the chemical structure of the infrared absorbing agent.

The ratio of the infrared absorbing agent around the fixed surface protective agent represents a ratio of the area A of the infrared absorbing agent existing within 0.5 μm from the contour of the fixed surface protective agent based on the entire area of the infrared absorbing agent including the area A in the image of a super thin toner section observed by a transmission electron microscope. 20 toner particles are used and the average of the ratios for the respective toner particles is determined as this ratio. The position of the infrared absorbing agent within the toner is determined as closer to the center area of the toner when the infrared absorbing agent is present at least 60% or higher in the inner area of the toner, closer to the surface when the infrared absorbing agent is present at least 60% or higher in the outer area of the toner, and not locally present when the infrared absorbing agent is present otherwise when the image is divided into two areas, i.e., the inner area and the outer area, relative to the half point of the radius of the toner based on the center of the mass thereof.

The toner of the present invention preferably has a volume average particle diameter of from 3 to 6 μm and more preferably from 4 to 6 μm. A volume average particle diameter that is too small may cause a problem in each process during image formation. To the contrary, a volume average particle diameter that is too large tends to decrease the definition of an image.

The toner of the present invention preferably has an average circularity of 0.95 or higher. An average circularity that is too small may lead to a bad transfer.

The toner of the present invention contains a binder resin, a coloring agent, a fixed surface protective agent, and an infrared absorbing agent and preferably an external additive is added to the toner. External additives improve fluidity, developability and transferability.

The product of the volume average particle diameter of the toner and the addition amount of such an external additive is preferably from 3 to 18 μm·% by weight. An excessively small product tends to degrade the transferability, which leads to production of images having hollow defects. This hollow defect easily occurs especially when a full color image is formed or a toner containing a fixed surface protective agent is used. When this product is too large, the fixing property tends to degrade and the fixing strength of a produced image is easily insufficient. The fixing strength easily deteriorates especially when a half tone image having a small attachment amount is fixed by a non-contact fixing device.

In addition, the toner of the present invention is suitable for dealing with various kinds of media from thin media to thick media to rough media and brimless images.

In the present invention, the transferability represents the degree of easiness of transfer when a toner image formed on the surface of an image bearing member is transferred to a transfer body. In addition, when a toner image on the surface of an image bearing member is once transferred to an intermediate transfer body such as an intermediate transfer belt and thereafter the toner image on the intermediate transfer body is transferred to a recording medium, the transferability represents the degree of easiness of transfer from the image bearing member to the intermediate transfer body and from the intermediate transfer mediate body to the recording medium.

The image forming apparatus of the present invention is described next.

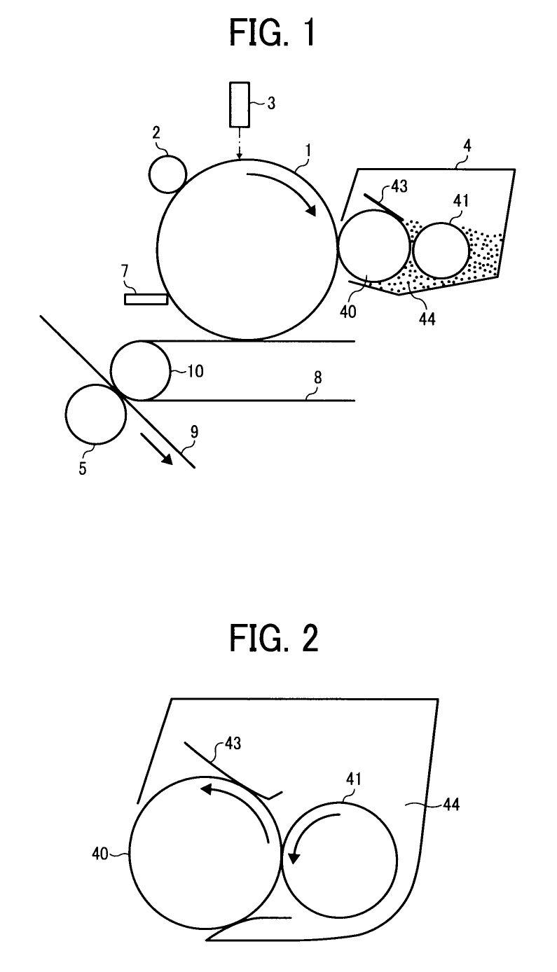

FIG. 1 is a schematic diagram illustrating an example of the image forming apparatus of the present invention. An image bearing member 1 is charged by a charging device 2 and thereafter irradiated with light by an irradiating device 3 so that a latent electrostatic image is written on the image bearing member 1. A bias is applied to a development roller 40 contained in a development unit 4 and the image bearing member 1. The written latent electrostatic image is developed and visualized at the contact point with a development agent 44 supplied from a supply roller 41 to a development roller 40 followed by regulation of the toner layer on the development roller 40 by a regulating blade 43. The development agent 44 used for development and visualization of the latent electrostatic image is temporarily transferred to an intermediate transfer material 44 and then to a recording medium 9 and fixed thereon by a fixing device. An extremely small amount of the development agent 44 passes through the intermediate transfer material 8 and remains on the image bearing member 1. The toner remaining on the surface of the image bearing member 1 after transfer is collected by a cleaning device 7 and discarded.

The development portion is described next.

FIG. 2 is a schematic diagram illustrating an example of the development unit (process cartridge) 4. The development agent (toner) 44 in the toner supply portion in the toner container is transferred to the nip portion of the development roller 40 where the development roller 40 nips the development agent 44 with the supply roller 41. Thereafter, the amount of the toner on the development roller 40 is regulated by the regulating blade 43 to form a thin layer of the toner on the development roller 40. In addition, the toner is abraded at the nip portion formed between the supply roller 41 and the development roller 40 and between the regulating blade 43 and the development roller 40 to have a suitable amount of charge. In the structure having no cleaning device, the amount of charge of the toner is significantly away from a suitable range and therefore, the toner collected by the development roller is sufficiently scraped and removed by the supply roller.

The non-contact fixing device is described below.

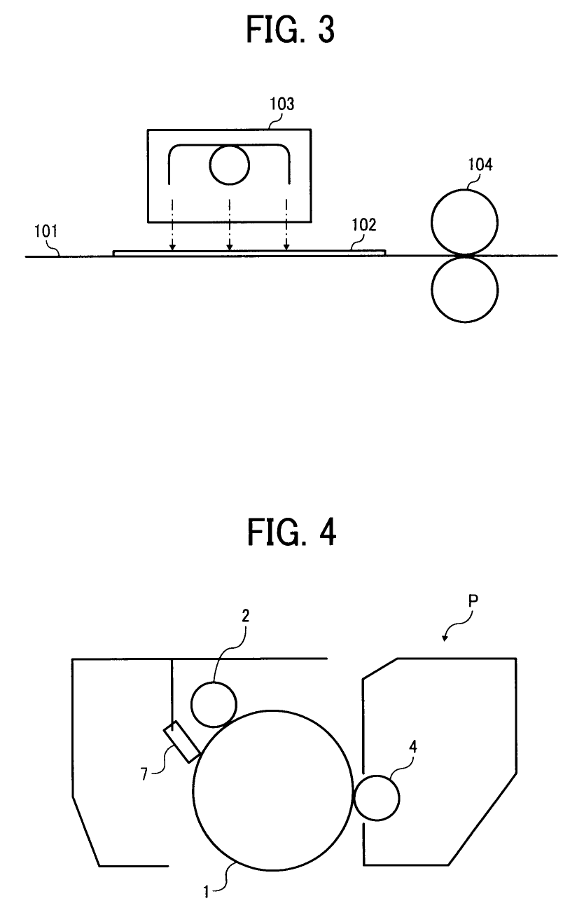

FIG. 3 is a schematic diagram illustrating an example of the non-contact fixing device for use in the present invention. Light flashes on a recording medium 102 such as paper transferred by a transfer belt 101 when the recording medium 102 passes through a flash fixing portion 103. Thus, the toner on the recording medium 102 such as paper is melted and fixed thereon. In addition, the gloss of the image on the recording medium 102 is improved by providing a smoothing mechanism 104 for smoothing the toner surface on the downstream side of the toner fixing.

A xenon lamp having emission spectrum peaks at least in the oscillation wavelength ranges of from 810 to 840 nm and from 900 to 980 nm can be used as the light source of the flash fixing portion.

In terms of space-saving and free-latitude of installation of an apparatus, size reduction thereof has been demanded. This trend is especially applicable to a printer using a single component development agent for which size reduction is effective. As such size reduction of an apparatus advances, each part therein should be reduced in size. This applies to the toner supply mechanism in a development device, which tends to cause a problem. That is, as the diameter of the development roller to develop a latent electrostatic image on the image bearing member with a toner and the diameter of the supply roller to supply the toner to the development roller decrease, the supply amount of the toner decreases. Therefore, the following property with regard to the amount of the toner required deteriorates, which easily causes unevenness of the density in a produced image. This problem is serious in the case of a toner having a small particle diameter, and more serious when such a toner further contains a fixed surface protective agent such as a wax.

The reason why the following property deteriorates due to the size reduction of the diameter of a development roller is considered to be that since a development roller having a small particle diameter has a small circumference length, the number of rotation should be increased to secure the amount of the toner required for development. Furthermore, because of the size reduction of the diameter of a development roller, the curvature radius thereof decreases so that the attachment of the development agent to the development roller tends to be difficult, which leads to deterioration of the following property. These problems are considered to be related to uneven transfer of the toner on the development roller. However, the toner of the present invention has a good fluidity and thus a good following property without causing the uneven transfer problem because the fixed surface protective agent or the infrared absorbing agent contained in the toner is not exposed to the surface of the toner.

A cleanerless system can be employed as a method of size reduction of an image forming apparatus in which a multiple color image is formed by sequentially transferring toner images developed on an image bearing member such as a photoreceptor drum atop on a transfer medium or a transfer body such as an intermediate transfer body by way of direct contact. This mechanism contributes to space saving because no cleaning blade mechanism is used. In this kind of the cleanerless system, a prior transferred toner image is transferred back from a transfer body to an image bearing member in the transfer process due to the direct contact. This causes color mixture, which results in deterioration of the quality of images.

It is inferred that this problem is caused by agglomeration of the toner on the transfer body such as an intermediate transfer body due to compression stress. However, in the toner of the present invention including a fixed surface protective agent and an infrared absorbing agent, which are not exposed to the surface of the toner, the toner agglomeration force is small and thus tends to hardly occur. As a result, transfer back of the toner hardly occurs.

The toner of the present invention preferably employs a core shell stricture. Such a core shell structure is formed of, for example, a core containing a coloring agent, a fixed surface protective agent and a binder resin (A) and a shell having a binder resin (B) covering the core. It is preferable that the binder resin (A) is mainly made of a polyester based resin and the binder resin (B) is a vinyl based copolymer. That is, the core forming the main component of toner includes a polyester based resin because the polyester based resin is advantageous in terms of a combination of the low temperature fixing property and the high temperature preservability and the shell portion, which has a significant impact on the chargeability of toner, includes a vinyl based copolymer since the vinyl based copolymer is preferred to control the chargeability.

Due to such a core shell structure, the infrared absorbing agent present around the fixed surface protective agent does not expose to the surface of the toner. Furthermore, when a latent electrostatic image is developed by using a development roller having a relatively small diameter in a single component development system, the shell portion absorbs the pressure applied to the toner, thereby preventing toner cracking and transformation.

The structure of the toner of the present invention is described in detail below.

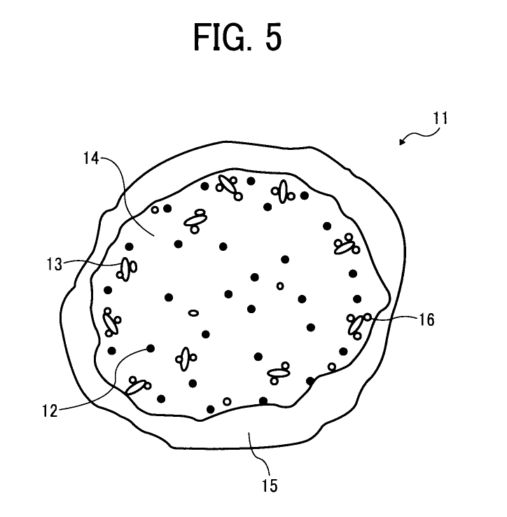

FIG. 5 is a diagram illustrating an example of the structure of the toner of the present invention. As illustrated in FIG. 5, a toner 11 of the present invention is formed of a core portion 14 containing a coloring agent 12, a fixed surface protective agent 13, a binder resin (A) and a shell portion 15 made of the binder resin (B) covering the core portion 14. The binder resin (A) is contains a polyester resin as the main component and the binder resin (B) is a vinyl based copolymer resin. That is, the core portion, i.e., the main component of the toner, is a polyester resin having an advantage in terms of a good combination of the low temperature fixing property and the high temperature preservability. In addition, the shell (surface) portion which has a great impact on the chargeability of the toner is a vinyl based copolymer resin which is advantageous to control the chargeability.

The glass transition temperature of the polyester resin is preferably from 40° C. or higher and more preferably from 45° C. or higher. A glass transition temperature that is too low tends to degrade the high temperature preservability.

The reasons why such a vinyl based copolymer resin is advantageous to control the chargeability are, for example, (1) multiple kinds of monomers available from a wide range of selection can be mixed for polymerization and polar groups such as carboxylic acid, sulfonic acid, etc., can be easily introduced thereto; and (2) the structure in the polymer particle can be adjusted by the polarity of selected monomers in a suspension polymerization or an emulsification polymerization so that desired functional groups deriving from the monomers are locally made to be present efficiently.

Therefore, a toner which is good with regard to the fixing property such as the low temperature fixing property and the development property and the transfer property which are affected by the chargeability is obtained. In addition, the weight ratio of the shell portion to the core portion is preferably from 0.05 to 0.5, more preferably from 0.07 to 0.4 and furthermore preferably from 0.1 to 0.3. When the weight ratio of the shell portion to the core portion is too small, the binder resin (B) of the vinyl based copolymer resin does not demonstrate the effect sufficiently. When the weight ratio of the shell portion to the core portion is too large, the amount of the binder resin (A) of the polyester resin is excessively small, resulting in an adverse impact on the fixing properties.

The toner of the present invention preferably has a softening point (Tm) from 115 to 140° C. When the softening point is too low, the compression strength is not easily secured and the fixing separation power tends to deteriorate in the fixing process in a mechanism without using oil by heating. When the softening point is too high, the fixing properties tend to deteriorate.

The toner of the present invention preferably satisfies the following relationships to improve the effect of the core shell structure.

RA(P)×0.5>RB(P)

and

RA(W)×0.5>RB(W)

In the relationships, RA(P) represents the ratio of the coloring agent in the core portion to the entire core portion and RA (W) represents the ratio of the fixed surface protective agent in the core portion to the entire core portion. RB(P) represents the ratio of the coloring agent in the shell portion to the entire shell portion and RB(W) represents the ratio of the fixed surface protective agent in the shell portion to the entire shell portion.

In addition, it is more preferable to satisfy the following relationship:

RA(P)×0.2>RB(P)

and

RA(W)×0.2>RB(W)

Additionally, it is furthermore preferable to satisfy the following relationship:

RA(P)×0.01>RB(P)

and

RA(W)×0.01>RB(W)

That is, it is preferable that the coloring agent and the fixed surface protective agent are not exposed to the toner surface and the ratio of the coloring agent and the fixed surface protective agent existing in the vicinity (the shell portion 5 illustrated in FIG. 5) of the toner surface is low. Since the coloring agent and the fixed surface protective agent are not exposed to the toner surface, filming ascribable to the fixed surface protective agent on the image bearing member is prevented and the chargeability of the obtained toner is excellent in terms of the anti-environment property. Therefore, the difference among the chargeability of each coloring agent for each color can be minimized in a full color toner. Therefore, the difference among the chargeability of each coloring agent for each color can be minimized in a full color toner.

### Polyester Resin

There is no specific limit to the kind of the polyester resin for use in the present invention and any kinds of polyester resins can be used. Also, a mixture of several kinds of polyester resins can be used. Specific examples of the polyester resins include, but are not limited to, condensation products of the following polyols (1) and the polycarboxylic acids (2).

### Polyol

Specific examples of the polyols (1) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F, and bisphenol S), 4,4′-dihydroxybiphenyls such as 3,3-difluoro-4,4′-dihydroxybiphenyl; bis(hydroxyphenyl)alkanes such as bis(3-fluoro-4-hydroxyphenyl)methane, 1-phenyl-1,1′-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also referred to as tetrafluorobisphenol A), and 2,2-bis(3-hydroxyphnyl)-1,1,1,3,3,3-hexafluoropropane; bis(4-hydorxyphenyl)ethers such as bis(3-fluoro-4-hydroxyphenyl)ether; adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms can be used.

Specific examples of the aliphatic polyols having three or more hydroxyl groups include, but are not limited to, glycerin, trimethylol ethane, trimethylol propane, pentaerythritol and sorbitol); polyphenols having three or more hydroxyl groups (trisphenol PA, phenol novolak and cresol novolak); and adducts of the polyphenols having three or more hydroxyl groups mentioned above with an alkylene oxide.

The polyols specified above can be used alone or in combination.

### Polycarboxylic Acids

Specific examples of the polycarboxylic acids (2) include, but are not limited to, alkylene dicarboxylic acids (e.g., succinic acid, adipic acid and sebacic acid); alkenylene dicarboxylic acids (e.g., maleic acid and fumaric acid); and aromatic dicarboxylic acids (e.g., phthalic acid, isophthalic acid, terephthalic acid, naphthalene dicarboxylic acids, 3-fluoroisophtahlic acid, 2-fluoroisophthalic acid, 2-fluoroterephtahlic acid, 2,4,5,6-tetrafluoroisophtahlic acid, 2,3,5,6-tetrafluoro terephthalic acid, 5-trifluoromthyl isophthalic acid, 2,2-bis(4-carboxyphenyl)hexafluoropropane, 2,2-bis(4-carboxyphenyl)hexafluoro propane, 2,2-bis(3-carboxyphenyl)hexafluoropropane, 2,2′-bis(trifluoromethyl)-4,4′-biphenyl dicarboxylic acid, 3,3′-bis(trifluoromethyl)4,4′-biphenyl dicarboxylic acid, 2,2′-bis(trifluoromethyl)-3,3′-biphenyl dicarboxylic acid, and hexafluoro isopropylidene diphthalic anhydride).

Among these compounds, alkenylene dicarboxylic acids having 4 to 20 carbon atoms and aromatic dicarboxylic acids having 8 to 20 carbon atoms are preferably used. Specific examples of the polycarboxylic acids having three or more hydroxyl groups include, but are not limited to, aromatic polycarboxylic acids having 9 to 20 carbon atoms (e.g., trimellitic acid and pyromellitic acid).

Anhydrides or lower alkyl esters (e.g., methyl esters, ethyl esters or isopropyl esters) of the polycarboxylic acids specified above can be used for the reaction with a polyol (1) to obtain the polycarboxylic acid.

The polycarboxylic acids specified above can be used alone or in combination and are not limited to the specified above.

### Ratio of Polyol and Polycarboxylic Acid

The suitable mixing ratio (i.e., an equivalence ratio [OH]/[COOH]) of a polyol (PO) to a polycarboxylic acid (PC) is from 2/1 to 1/1, preferably from 1.5/1 to 1/1 and more preferably from 1.3/1 to 1.02/1.

The peak molecular weight is from 1,000 to 30,000, preferably from 1,500 to 10,000 and more preferably from 2,000 to 8,000. When the peak molecular weight is too small, the high temperature of the toner tends to deteriorate. When the peak molecular weight is too large, the low temperature fixing property easily deteriorates.

### Vinyl Based Copolymer Resin

There is no specific limit to the selection of the vinyl based copolymer resins for use in the present invention and any can be used. Also, a mixture of several kinds of vinyl based copolymer resins can be used.

The vinyl based copolymer resins are copolymerized polymers of vinyl based monomers. Specific examples of the vinyl based monomers include, but are not limited to, the following (1) to (10).

### (1) Vinyl Based Hydrocarbon

Aliphatic vinyl based hydrocarbons: alkenes such as ethylene, propylene, butane, isobutylene, pentene, heptene, diisobutylene, octane, dodecene, octadecene, α-olefins other than the above mentioned; alkadiens such as butadiene, isoplene, 1,4-pentadiene, 1,6-hexadiene, and 1,7-octadiene

Alicyclic vinyl based hydrocarbons: mono- or di-cycloalkenes and alkadiens such as cyclohexene, (di)cyclopentadiene, vinylcyclohexene, and ethylidene bicycloheptene; and terpenes such as pinene, limonene and indene.

Aromatic vinyl-based hydrocarbons: styrene and its hydrocarbyl (alkyl, cycloalkyl, aralkyl and/or alkenyl) substitutes, such as a-methylstyrene, vinyl toluene, 2,4-dimethylstyrene, ethylstyrene, isopropyl styrene, butyl styrene, phenyl styrene, cyclohexyl styrene, benzyl styrene, crotyl benzene, divinyl benzene, divinyl toluene, divinyl xylene, and trivinyl benzene; and vinyl naphthalene.

### (2) Vinyl Based Monomer Containing Carboxyl Group and Its Salts

Unsaturated mono carboxylic acid and unsaturated dicarboxylic acid having 3 to 30 carbon atoms, and their anhydrides and their monoalkyl (having 1 to 24 carbon atoms) esters, such as vinyl based monomers having carboxylic group such as (meth)acrylic acid, (anhydride of) maleic acid, mono alkyl esters of maleic acid, fumaric acid, mono alkyl esters of fumaric acid, crotonic acid, itoconic acid, mono alkyl esters of itaconic acid, glycol monoether of itaconic acid, citraconic acid, mono alkyl esters of citraconic acid and cinnamic acid.

### (3) Vinyl Based Monomer Having Sulfonic Group, Monoesterified Vinyl Based Sulfuric Acid and Their Salts

Alkene sulfuric acid having 2 to 14 carbon atoms such as vinyl sulfuric acid, (meth)aryl sulfuric acid, methylvinylsufuric acid and styrene sulfuric acid; their alkyl delivatives having 2 to 24 carbon atoms such as α-methylstyrene sulfuric acid; sulfo(hydroxyl)alkyl-(meth)acrylate or (meth)acryl amide such as sulfopropyl(meth)acrylate, 2-hydroxy-3-(meth)acryloxy propylsulfuric acid, 2-(meth)acryloylamino-2,2-dimethylethane sulfuric acid, 2-(meth)acryloyloxyethane sulfuric acid, 3-(meth)acryloyloxy-2-hydroxypropane sulfuric acid, 2-(meth)acrylamide-2-methylpropane sulfuric acid, 3-(meth) avrylamide-2-hydroxy propane sulfuric acid, alkyl (having 3 to 18 carbon atoms) aryl sulfosuccinic acid, sulfuric esters of poly(n=2 to 30) oxyalkylene (ethylene, propylene, butylenes: (mono, random, block) mono(meth)acrylate such as sulfuric acid ester of poly (n=5 to 15) oxypropylene monomethacrylate, and sulfuric acid ester of polyoxyethylene polycyclic phenyl ether.

### (4) Vinyl Based Monomer Having Phosphoric Group and Its Salts

Phosphoric acid monoester of (meth)acryloyl oxyalkyl such as 2-hydroxyethyl(meth)acryloyl phosphate, phenyl-2-acyloyloxyethylphosphate, (meth)acryloyloxyalkyl (having 1 to 24 carbon atoms) phosphonic acids such as 2-acryloyloxy ethylphosphonic acid and their salts, etc.

Specific examples of the salts of the compounds of (2) to (4) include, but are not limited to, alkali metal salts (sodium salts, potassium salts, etc.), alkali earth metal salts (calcium salts, magnesium salts, etc.), ammonium salts, amine salts, quaternary ammonium salts, etc.

### (5) Vinyl Based Monomer Having Hydroxyl Group

Hydroxystyrene, N-methylol(meth)acryl amide, hydroxyethyl(meth)acrylate, (meth)arylalcohol, crotyl alcohol, isocrotyl alcohol, 1-butene-3-ol, 2-butene-1-ol, 2-butene-1,4-diol, propargyl alcohol, 2-hydroxyethylpropenyl ether, simple sugar aryl ether, etc.

### (6) Vinyl Based Monomer Having Nitrogen

Vinyl based monomer having an amino group: aminoethyl(meth)acrylate, dimethylaminoethyl(meth)acrylate, diethylaminoethyl(meth)acrylate, t-butylaminoethyl(meth)acrylate, N-aminoethyl(meth)acrylamide, (metha)arylamine, morpholino ethyl(meth)acrylate, 4-vinylpyridine, 2-vinylpyridine, crotyl amine, N,N-dimethylaminostyrene, methyl-α-acetoaminoacrylate, vinylimidazole, N-vinylpyrrole, N-vinylthiopyrolidone, N-arylphenylene diamine, aminocarbozole, aminothiazole, aminoindole, aminopyrrole, aminoimidazole, and aminomercaptothiazole and their salts.

Vinyl Based Monomer Having Amide Group: (meth)acrylamide, N-methyl(meth)acrylamide, N-butylacrylamide, diacetone acrylamide, N-methylol(meth)acrylamide, N,N-methylene-bis(meth)acrylamide, cinnamic amide, N,N-dimethylacrylamide, N,N-dibenzylacrylamide, methacrylformamide, N-methyl-N-vinylacetoamide, and N-vinylpyrolidone.

Vinyl Based Monomer Having Nitrile Group: (meth)acrylonitrile, cyanostyrene and cyanoacrylate.

Vinyl Based Monomer Having Quaternary Ammonium Group: quaternarized vinyl based monomer having tertiary amine group such as dimethylaminoethyl(meth)acrylate, diethylaminoethyl(meth)acrylate, dimethylaminoethyl(meth)acrylamide, diethylaminoethyl(meth)acrylamide, diarylamine, etc. (quaternaized by using a quaternarizing agent such as methylchloride, dimethyl sulfuric acid, benzyl chloride, dimethylcarbonate).

Vinyl Based Monomer Having Nitro Group: nitrostyrene, etc.

### (7) Vinyl Based Monomer Having Epoxy Group

Glycidyl(meth)acrylate, tetrahydrofurfuryl(meth)acrylate, and p-vinylphenyl phenyloxide.

### (8) Vinyl Esters, Vinyl(thio)ether, Vinylketone, Vinyl Sulfonic Acid

Vinyl esters: Vinyl acetate, vinyl butylate, vinyl propionate, vinyl butyrate, diarylphthalate, diaryladipate, isopropenyl acetate, vinylmethacrylate, methyl-4-vinylbenzoate, cyclohexylmethacrylate, benzylmethacrylate, phenyl(meth)acrylate, vinylmethoxyacetate, vinylbenzoate, ethyl-α-ethoxyacrylate, alkyl (having 1 to 50 carbon atoms) (meth)acrylate such as methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, and eicocyl(meth)acrylate), dialkyl malate (in which two alkyl groups are straight chained, branch chained, or cyclic chained groups and have 2 to 8 carbon atoms), poly(meth)aryloxyalkanes such as diaryloxyethane, triaryloxyethane, tetraaryloxyethane, tetraaryloxypropane, tetraaryloxybutane and tetrametharyloxyethane, vinyl based monomers having polyalkylene glycol chain such as polyethylene glycol (molecular weight: 300) mono(meth)acrylate, polypropylene glycol (molecular weight: 500) monoacrylate, adducts of (meth)acrylate with 10 mol of methylalcoholethyleneoxide, and adducts of (meth)acrylate with 30 mol of lauryl alcohol ethylene oxide), poly(meth)acrylates such as poly(meth)acrylates of polyhydroxyl alcohols (e.g., ethylene glycol di(meth)acrylate, propylene glycol di(meth)acrylate, neopentylglycol di(meth)acrylate, trimethylol propane tri(meth)acrylate, and polyethylene glycol di(meth)acrylate).

Vinyl(thio)ethers: vinylmethyl ether, vinylethyl ether, vinylpropyl ether, vinylbutyl ether, vinyl-2-ethylhexyl ether, vinylphneyl ether, vinyl-2-methoxyethyl ether, methoxy butadiene, vinyl-2-buthxyethyl ether, 3,4-dihydro-1,2-pyrane, 2-buthoxy-2′-vinyloxy diethyl ether, vinyl-2-ethylmercapto ethylether, acetoxystyrene and phenoxy styrene.

Vinyl ketones: vinyl methylketone, vinylethylketone, and vinyl phenylketone.

Vinyl sulfone: divinyl sulfide, p-vinyl diphenyl sulfide, vinyl ethylsulfide, vinyl ethylsulfone, divinyl sulfone, and divinyl sulfoxide.

### (9) Other Vinyl Based Monomer

Isocyanate ethyl(meth)acrylat, and m-isopropenyl-α,α-dimethylbenzyl isocyanate.

### (d) Vinyl Based Monomer Having Fluorine Atom

4-fluorostyrene, 2,3,5,6-tetrafluorostyrene, pentafluorophenyl(meth)acrylate, pentafluorobenzyl(meth)acrylate, perfluorocyclohexyl(meth)acrylate, perfluorocyclohexylmethyl(meth)acrylate, 2,2,2-trifluoroethyl(meth)acrylate, 2,2,3,3-tetrafluoropropyl(meth)acrylate, 1H,1H,4H-hexafluorobutyl(meth)acrylate, 1H,1H,4H-hexafluorobutyl(meth)acrylate, 1H,1H,5H-ocatafluoropentyl(meth)acrylate, 1H,1H,7H-dodecafluoroheptyl(meth)acrylate, perflurooctyl(meth)acrylate, 2-perfluorooctylethyl(meth)acrylate, heptadecafluorodecyl(meth)acrylate, trihydroperfluoroundecyl(meth)acrylate, perfluoronorbonyl(meth)acrylate, 1H-perfluoroisobornyl(meth)acrylate, 2-(N-butylperfluorooctane sulfone amide)ethyl(meth)acrylate, 2-(N-ethylperfluorooctane sulfone amide)ethyl(meth)acrylate, and derivatives introduced from α-fluoroacrylic acid.

Bis-hexafluoroiso propyl itaconate, bis-hexafluoro isopropyl malate, bis-perfluorooctyl itaconate, bis-perfluorooctyl malate, bis-trifluoroethyl itaconate, and bis-trifluoroethyl malate.

Vinylheptafluorobutylate, vinyl perfluoroheptanoate, vinyl perfluoro nonanoate and vinyl perfluoro octanoate.

### Vinyl Based Copolymer

As copolymers of a vinyl based monomer, copolymerized polymers formed of any two or more monomers of the compounds of (1) to (10) with an arbitral ratio can be used. Specific examples thereof include, but are not limited to, ester copolymers of styrene and (meth)acrylic acid, styrene-butadiene copolymers, ester copolymers of (meth)acrylic acid and acrylic acid, copolymers of styrene and acrylonitrile, copolymers of styrene and anhydride of malaic acid, copolymers of styrene and (meth)acrylic acid, copolymers of styrene and (meth)acrylic acid and divinyl benzene, and ester copolymers of styrene, styrene sulfonic acid and (meth)acrylic acid.

### Vinyl Based Copolymer Resin Particulate

It is preferable to use vinyl based copolymer resin particulates dispersed in an aqueous medium as the vinyl based copolymers specified above for use in manufacturing the toner. Vinyl based copolymer resin particulates are easily manufactured by a typical emulsification polymerization. In addition, the binder resin (B) in the toner of the present invention is preferably formed by agglomeration and/or adhesion of particulates formed of a vinyl based copolymer resin. The core portion can be tightly, smoothly and evenly covered by using the agglomeration body of particulates as the shell portion and more tightly, smoothly and evenly covered when an adhesion body of particulates is used instead. This has a good impact on stability of the charge amount distribution and improvement on transferability.

### Modified Polyester Resin

The binder resin (A) specified above for use in the present invention may include a polyester resin elongated by urethane and/or urea linkage (hereinafter referred to as a modified polyester resin having an urethane and/or urea group) to adjust the viscosity and elasticity for prevention of offset. The content ratio of the modified polyester resin having an urethane and/or urea group in the binder resin (A) specified above is preferably not greater than 20% by weight. A content ratio that is too high tends to degrade the low temperature fixing property. A content ratio that is too low easily leads to deterioration of compression strength. The modified polyester resin having an urethane and/or urea group can be directly mixed with the binder resin (A) but is preferably manufactured by mixing a modified polyester having an isocyanate group at its end and a relatively low molecular weight (hereafter referred to as prepolymer), an amine reactive therewith and the binder resin (A) followed by elongation reaction and/or cross-linking reaction during or after granulation to obtain a modified polyester resin having an urethane and/or urea group. Thereby, a modified polyester resin having a relatively high molecular weight for use in adjustment of viscosity and elasticity can be easily contained in the core portion.

### Prepolymer

The polyester prepolymer mentioned above can be prepared by, for example, reacting a polyester having an active hydrogen group, which is a polycondensation product of a polyol (1) and a polycarboxylic acid (2), and a polyisocyanate (3). Specific examples of the active hydrogen group contained in the polyester mentioned above including the mentioned above include, but are not limited to, hydroxyl groups (alcohol hydroxyl groups and phenol hydroxyl groups), amino groups, carboxylic groups, and mercarpto groups. Among these, alcohol hydroxyl groups are particularly preferred.

### Polyisocyanate

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α,α,α′,α′-tetramethyl xylylene diisocyanate); isocyanurates; blocked polyisocyanates in which the polyisocyanates mentioned above are blocked with phenol derivatives thereof, oximes or caprolactams; etc. These compounds can be used alone or in combination.

### Ratio of Isocyanate Group and Hydroxyl Group

Suitable mixing ratio (i.e., [NCO]/[OH]) of a polyisocyanate (PIC) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner tends to deteriorate. When the molar ratio of [NCO] is too small, the urea content of a modified polyester tends to be small and the hot offset resistance easily deteriorates.

The content of the constitutional component of a polyisocyanate (PIC) in the polyester prepolymer (A) having a polyisocyanate group at its end portion is from 0.5 to 40% by weight, preferably from 1 to 30% by weight and more preferably from 2 to 20% by weight. When the content is too low, the hot offset resistance of the toner easily deteriorates. In contrast, when the content is too high, the low temperature fixability of the toner tends to deteriorate.

### Number of Isocyanate Groups in Prepolymer

The number of isocyanate groups included in the prepolymer (A) per molecule is normally not less than 1, preferably from 1.5 to 3, and more preferably from 1.8 to 2.5. When the number of isocyanate groups is too small, the molecular weight of urea-modified polyester tends to be small and the hot offset resistance easily deteriorates.

Elongation Agent and/or Cross Linking Agent

In the present invention, amines can be used as an elongation agent and/or a cross linking agent. Specific examples of the amines (B) include, but are not limited to, diamines (B1), polyamines (B2) having three or more amino groups, amino alcohols (B3), amino mercaptans (B4), amino acids (B5), and blocked amines (B6) in which the amines (B1-B5) mentioned above are blocked.

Specific examples of the diamines (B1) include, but are not limited to, aromatic diamines (e.g., phenylene diamine, diethyltoluene diamine, 4,4′-diaminodiphenyl methane, tetrafluoro-p-xylylene diamine, and tetrafluoro-p-phenylene diamine); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine, hexamethylene diamine, dodecafluorohexylene diamine, and tetracosafluorododecylene diamine); etc.

Specific examples of the polyamines (B2) having three or more amino groups include, but are not limited to, diethylene triamine, and triethylene tetramine.

Specific examples of the amino alcohols (B3) include, but are not limited to, ethanol amine and hydroxyethyl aniline.

Specific examples of the amino mercaptan (B4) include, but are not limited to, aminoethyl mercaptan and aminopropyl mercaptan.

Specific examples of the amino acids (B5) include, but are not limited to, amino propionic acid and amino caproic acid.

Specific examples of the blocked amines (B6) include, but are not limited to, ketimine compounds which are prepared by reacting one of the amines B1-B5 mentioned above with a ketone such as acetone, methyl ethyl ketone and methyl isobutyl ketone; oxazoline compounds, etc.

### Molecular Weight Control Agent

Furthermore, the molecular weight of the modified polyesters after the cross linking reaction and/or the elongation reaction can be controlled by using a molecular-weight control agent, if desired. Specific examples of the molecular-weight control agent include, but are not limited to, monoamines (e.g., diethyl amine, dibutyl amine, butyl amine and lauryl amine), and blocked amines (i.e., ketimine compounds) prepared by blocking the monoamines mentioned above.

### Ratio of Amino Group and Isocyanate Group

The mixing ratio of the isocyanate group to the amines (B), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant urea-modified polyester (i) decreases, resulting in deterioration of the hot offset resistance of the resultant toner.

### Coloring Agent

Suitable coloring agents (coloring material) for use in the toner of the present invention include known dyes and pigments. Specific examples of the coloring agents include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromiumoxide, viridian, emerald green, Pigment Green B, Naphthol Green B. Green Gold, Acid Green Lake, Malachite Green Lake, Phthalocyanine Green, Anthraquinone Green, titanium oxide, zinc oxide, lithopone and the like. These materials can be used alone or in combination. The content of the coloring agent is from 1 to 15% by weight and preferably from 3 to 10% by weight based on the toner.

### Coloring Agent As Master Batch

Master batch pigments, which are prepared by combining a coloring agent with a resin, can be used as the coloring agent of the toner composition of the present invention. Specific examples of the resins for use in the master batch pigments or for use in combination with master batch pigments include, but are not limited to, the modified polyester resins and the unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination.

### Method of Manufacturing Master Batch

The master batch for use in the toner of the present invention is typically prepared by mixing and kneading a resin and a coloring agent upon application of high shear stress thereto. In this case, an organic solvent can be used to boost the interaction of the coloring agent with the resin. In addition, flushing methods in which an aqueous paste including a coloring agent is mixed with a resin solution of an organic solvent to transfer the coloring agent to the resin solution and then the aqueous liquid and organic solvent are separated to be removed can be preferably used because the resultant wet cake of the coloring agent can be used as it is. In this case, three-roll mills, etc. can be preferably used for kneading the mixture upon application of high shear stress thereto.

### Fixed Surface Protective Agent

A release agent may be included in the toner of the present invention. Suitable release agents include known waxes.

Specific examples of the release agent include, but are not limited to, polyolefin waxes such as polyethylene waxes and polypropylene waxes; long chain hydrocarbons such as paraffin waxes and SAZOL waxes; waxes including a carbonyl group, etc.; rice wax and synthetic esters.

Specific examples of the waxes including a carbonyl group include, but are not limited to, polyalkane acid esters such as carnauba wax, montan waxes, trimethylolpropane tribehenate, pentaerythritol tetrabehenate, pentaerythritol diacetate dibehenate, glycerin tribehenate, and 1,18-octadecanediol distearate; polyalkanol esters such as trimellitic acid tristearyl, and distearyl maleate; polyalkylamide such as trimellitic acid tristearylamide; dialkyl ketone such as distearyl ketone, etc. Among these materials, polyalkane acid esters are preferred.

In the present invention, the content of the fixed surface protective agent (wax) in the toner is preferably from 3 to 30% by weight based on the entire content of the toner. When the content of the fixed surface protective agent is too small, the fixed surface protective agent is not effective to demonstrate the releasing effect, thereby losing a margin for smear protection. When the content of the fixed surface protective agent is too large, the fixed surface protective agent tends to melt at a low temperature so that the fixed surface protective agent is easily affected by thermal energy and mechanical energy. Thus, the fixed surface protective agent easily oozes from the inside of the toner during stirring in the development device and attaches to the toner regulating applicator (blade) and the image bearing member, which may lead to the occurrence of the image noise. The toner can be fixed at a low temperature when the endothermic peak of the fixed surface protective agent at temperature rising measured by a differential scanning calorimeter (DSC) ranges from 65 to 115° C. An endothermic peak that is too low tends to degrade the fluidity. An endothermic peak that is too high tends to degrade the fixing property.

### Charge Controlling Agent

A charge controlling agent may be included in the toner of the present invention.

Specific examples of the charge controlling agent include, but are not limited to, known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc.

Specific examples of the marketed products of the charge controlling agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

### External Additive

### Inorganic Particulate

An external additive can be added to the toner of the present invention to help improving the fluidity, developability, chargeability of the coloring agent prepared or obtained in the present invention. Inorganic particulates are suitably used as such an external additive. It is preferred for the inorganic particulate to have a primary particle diameter of from 5 nm to 2 μm, and more preferably from 5 nm to 500 nm. In addition, it is preferred that the specific surface area of such inorganic particulates measured by the BET method is from 20 to 500 m²/g. The content of such an inorganic particulate is preferably from 0.01 to 5% by weight and particularly preferably from 0.01 to 2.0% by weight based on the weight of a toner.

Specific examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, complex compounds such as silicon oxide and magnesium oxide or silicon oxide and aluminum oxide, zirconium oxide, barium sulfate, barium carbonate, calcium carbonate, silicon carbide, silicon nitride, etc.

### Polymer Particulate

In addition, polymer particulates, such as polystyrene, methacrylate copolymers and acrylate copolymers, which are obtained by soap-free emulsification polymerization and suspension polymerization and dispersion polymerization, and polycondensation thermocuring resin particles, such as silicone, benzoguanamine and nylon, can be used.

### Surface Treatment of External Additive

The fluidizers (external additives) specified above can be surface-treated to improve the hydrophobic property and prevent deterioration of the fluidity characteristics and chargeability in a high humidity environment. Preferred specific examples of surface treatment agents include, but are not limited to, silane coupling agents, silyl agents, silane coupling agents having a fluorine alkyl group, organic titanate coupling agents, aluminum-based coupling agents, silicone oil, and modified-silicone oil.

### Cleaning Property Improver

As a cleaning property improver to remove a development agent remaining on an image bearing member or a primary transfer medium after transfer, stearic acid, aliphatic metal salts, for example, zinc stearate and calcium stearate, and polymer particulates manufactured by soap-free emulsification polymerization, such as polymethyl methacrylate particulates and polystyrene particulates, can be used. Such polymer particulates preferably have a relatively sharp particle size distribution and a volume average particle size of from 0.01 to 1 μm.

### Method of Manufacturing Toner

A preferable example method of manufacturing the toner of the present invention is described below but the method of manufacturing the toner of the present invention is not limited thereto.

The method of manufacturing the toner of the present invention includes at least a granulation process in which at least a polyester resin, a coloring agent and a fixed surface protective agent are dissolved or dispersed in an organic solvent and thereafter the lysate or dispersed material is dispersed in an aqueous medium to granulate core particles and an attachment process of particulates to the core particles in which an aqueous liquid dispersion in which at least vinyl based copolymer resin particulates are dispersed is added to the core particles.

The method is described in detail below.

### Granulation of Core Particles

### Organic Solvent

The organic solvent that dissolves or disperses a toner composition formed of a polyester resin, a coloring agent and a fixed surface protective agent preferably has a Hansen dissolution parameter of not greater than 19.5. The Hansen dissolution parameter is described in, for example, Section VII in Volume 2 of “Polymer Handbook” 4th edition published by Wiley-Interscience. Considering that the solvent is removed later, the boiling point of the solvent is preferably lower than 100° C. Specific examples thereof include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone and methylisobuthyl ketone. These can be used alone or in combination. Among these, ester based solvents such as methyl acetate and ethyl acetate, aromatic based solvent such as toluene and xylene, and halogenized hydrocarbons such as methylene chloride, 1,2-dichloroethane, chloroform and carbon tetrachloride are especially preferred. The polyester resin, the coloring agent and the fixed surface protective agent can be simultaneously dissolved or dispersed but typically dissolved or dispersed in separate occasions. The organic solvent to dissolve or disperse each of the polyester resin, the coloring agent and the fixed surface protective agent can be the same or different but using the same organic solvent is preferable considering the subsequent solvent treatment.

### Dissolution or Dispersion of Polyester Resin

The resin density in the liquid dissolution or dispersion of a polyester resin is preferably from about 40 to 80% by weight. A resin density that is too high tends to make dissolution or dispersion difficult and the viscosity high so that handling liquid dissolution or dispersion is difficult. When the resin density is too low, the amount of produced toner tends to decrease. When a modified polyester resin having an isocyanate group at its end is mixed with a polyester resin, the modified polyester resin and the polyester resin can be mixed in the same liquid dissolution or dispersion or manufactured separately in different liquid dissolution or dispersion. Considering the solubility and the viscosity thereof, it is preferable to separately prepare different liquid dissolution or dispersion.

### Dissolution or Dispersion of Coloring Agent

The coloring agent can be separately dissolved or dispersed or mixed with the liquid dissolution or dispersion of the polyester resin. If desired, a dispersion helping agent or a polyester resin can be added or the master batch specified above can also be used.

### Dissolution or Dispersion of Fixed Surface Protective Agent

When a wax is dissolved or dispersed as the fixed surface protective agent and an organic solvent in which the wax is not soluble is used, the resultant is used as a liquid dispersion. Such a liquid dispersion is prepared by a typical method, in which an organic solvent and a wax are mixed followed by dispersion treatment by a dispersion device such as a bead mill. Alternatively, after mixing an organic solvent and a wax, the wax is heated to the melting point thereof and cooled down while being stirred. Thereafter, the mixture is dispersed by a dispersion device such as a bead mill. In this method, the dispersion time may be reduced. Furthermore, several kinds of waxes can be mixed for use and a dispersion improving agent or a polyester resin can be optionally added.

### Aqueous Medium

Suitable aqueous media for use in the present invention include water, and mixtures of water with a solvent which can be mixed with water. Furthermore, the organic solvent mentioned above for use in the liquid dissolution or dispersion having a Hansen dissolution parameter of not greater than 19.5 can be mixed. When such an organic solvent is added to water in an amount close to the saturation amount, the emulsification or dispersion stability of the oil phase added to the aqueous medium can be improved. Specific examples of such a solvent include, but are not limited to, alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc. The amount of an aqueous medium is normally from 50 to 2,000 parts by weight and preferably from 100 to 1,000 parts by weight based on 100 parts by weight of a toner composition. When the amount of an aqueous medium is too small, the dispersion stability of a toner composition is degraded so that toner particles having a desired particle diameter are not obtained. An amount of an aqueous medium that is excessively large is not preferred in terms of economy.

### Inorganic Dispersion Agent and Organic Resin Particulate

The lysate or dispersion material of the toner composition mentioned above is preferably dispersed in an aqueous medium in which an inorganic dispersion agent or organic resin particulates are preliminarily dispersed to have a sharp particle size distribution and stabilize the dispersion. Specific examples of the inorganic dispersion agent include, but are not limited to, tricalcium phosphate, calcium carbonate, titanium oxide, colloidal silica and hydroxyapatite. There is no specific limit to selection of resins that form resin particulates as long as the resin can form a dispersion body in an aqueous medium. A dispersion body having fine spherical resin particulates is preferred. Any thermoplastic resins or thermocuring resins can be used as resin particulates. Specific examples thereof include, but are not limited to, vinyl based resins, polyurethane resins, epoxy resins, polyester resins, polyamide resins, polyimide resins, silicon based resins, phenol resins, melamine resins, urea resins, aniline resins, ionomer resins, and polycarbonate resins. These resins can be used alone or in combination. Among these, vinyl resins, polyurethane resins, epoxy resins and polyester resins and their combinational use are preferred in terms that a dispersion body having fine spherical resin particulates is easy to obtain.

### Method of Dispersing Organic Resin Particulate in Aqueous Medium

There is no specific limit to the method of preparing an aqueous liquid dispersion of resin particulates from a resin. For example, the following methods of (a) to (h) can be used.
(a) A method of manufacturing an aqueous liquid dispersion of resin particulate directly from the polymerization reaction by a suspension polymerization method, an emulsification polymerization method, a seed polymerization method or a dispersion polymerization method from a monomer as the start material in the case of a vinyl based resin.
(b) A method of manufacturing an aqueous liquid dispersion of resin particulates by: dispersing a precursor (monomer, oligomer, etc.) or its solvent solution under the presence of a suitable dispersion agent; and curing the resultant by heating and/or adding a curing agent in the case of a polyaddition or polycondensation resin such as a polyester resin, a polyurethane resin and an epoxy resin.
(c) In the case of a polyaddition or polycondensation resin such as a polyester resin, a polyurethane resin and an epoxy resin, a method of manufacturing an aqueous liquid dispersion of resin particulates by dissolving a suitable emulsification agent in a precursor (monomer, oligomer, etc.) or its solvent solution (liquid is preferred, e.g., liquidized by heating) followed by adding water for phase change.
(d) A method of manufacturing an aqueous liquid dispersion of resin particulates by: fine-pulverizing resins preliminarily manufactured by a polymer reaction (addition polymerization, ring scission polymerization, polyaddition, addition condensation, polycondensation, etc.) with a fine grinding mill of a mechanical rotation type or jet type; classifying the resultant; and dispersing the obtained resin particulates in water under the presence of a suitable dispersion agent.
(e) A method of manufacturing an aqueous liquid dispersion of resin particulates by: spraying in the form of a fine liquid mist a resin solution in which resins preliminarily manufactured by a polymer reaction (addition polymerization, ring scission polymerization, polyaddition, addition condensation, polycondensation, etc.) are dissolved in a solvent; and dispersing the obtained resin particulates in water under the presence of a suitable dispersion agent.
(f) A method of manufacturing an aqueous liquid dispersion of resin particulates by: precipitating resin particulates by adding a solvent to a resin solution in which resins preliminarily manufactured by a polymer reaction (addition polymerization, ring scission polymerization, polyaddition, addition condensation, polycondensation, etc.) are dissolved in another solvent or cooling the resin solution preliminarily prepared by heating and dissolving in a solvent; removing the solvent to obtain the resin particulates; and dispersing the obtained resin particulates in water under the presence of a suitable dispersion agent.
(g) A method of manufacturing an aqueous liquid dispersion of resin particulates by: dispersing in an aqueous medium a resin solution in which resins preliminarily manufactured by a polymer reaction (addition polymerization, ring scission polymerization, polyaddition, addition condensation, polycondensation, etc.) are dissolved in a solvent under the presence of a suitable dispersion agent; and removing the solvent by heating, reducing pressure, etc.
(h) A method of manufacturing an aqueous liquid dispersion of resin particulates by: dissolving a suitable emulsification agent in a resin solution in which resins preliminarily manufactured by a polymer reaction (addition polymerization, ring scission polymerization, polyaddition, addition condensation, polycondensation, etc.) are dissolved in a solvent; and adding water for phase change.

To emulsify and/or disperse an oil phase containing a toner composition in an aqueous medium, a surface active agent can be used, if desired. Specific examples of the surface active agents include, but are not limited to, anionic dispersion agents, for example, alkylbenzene sulfonic acid salts, a-olefin sulfonic acid salts, and phosphoric acid salts; cationic dispersion agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersion agents, for example, fatty acid amide derivatives, polyhydric alcohol derivatives; and ampholytic dispersion agents, for example, alanine, dodecyldi(aminoethyl)glycin, di(octylaminoethyle)glycin, and N-alkyl-N,N-dimethylammonium betaine.

A surface active agent having a fluoroalkyl group is effective in an extremely small amount for a good dispersion. Preferred specific examples of the anionic surface active agents having a fluoroalkyl group include, but are not limited to, fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc. Specific examples of the cationic surface active agents having a fluoroalkyl group include, but are not limited to, primary and secondary aliphatic amino acids, secondary amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts.

### Protective Colloid

It is possible to stabilize liquid droplet dispersion in an aqueous medium using a polymeric protection colloid. Specific examples of such polymeric protection colloids include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or a heterocyclic ring having a nitrogen atom (e.g., vinyl pyridine, vinyl pyrrolidone, vinyl imidazole and ethylene imine).

In addition, polymers, for example, polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid. When compounds, for example, calcium phosphate, which are soluble in an acid or alkali, are used as a dispersion stabilizer, it is possible to dissolve the calcium phosphate by adding an acid, for example, hydrochloric acid, followed by washing of the resultant particles with water, to remove the calcium phosphate from particulates. In addition, a zymolytic method can be used to remove such compounds. Such a dispersion agent may remain on the surface of toner particles. However, it is preferred to wash and remove the dispersion agent in terms of the charging property of toner particles.

### Dispersion Method

There is no particular limit to the dispersion method. Low speed shearing methods, high speed shearing methods, friction methods, high pressure jet methods, ultrasonic methods, etc., can preferably be used. Among these methods, high speed shearing methods are more preferable because particles having a particle diameter of from 2 to 20 μm can be easily prepared. When a high speed shearing type dispersion machine is used, there is no particular limit to the rotation speed thereof, but the rotation speed is typically from 1,000 to 30,000 rpm, and preferably from 5,000 to 20,000 rpm. The temperature during the dispersion process is typically from 0 to 150° C. (under pressure), and preferably from 20 to 80° C.

### Solvent Removal

Any known methods can be used to remove organic solvents from the obtained emulsified dispersion body.

For example, a method can be employed in which the system is gradually heated under normal pressure or with a reduced pressure to completely evaporate and remove organic solvent in the droplets.

### Attachment Process of Particulate

The process of attaching particulates mainly formed of a vinyl based copolymer resin to the core particles mainly formed of a polyester resin is described. In this process, using an aqueous liquid dispersion in which at least vinyl based copolymer particulates are dispersed is suitable. This liquid dispersion is easily manufactured by a typical emulsification polymerization method and can be used in the attachment process as it is. To stabilize the core particles and the particulates in some degree, a surface active agent can be suitably added. A preferable timing of adding the particulates is after removal of organic solvent.

To conduct attachment more efficiently, sodium hydroxide or hydrochloric acid can be added to adjust PH in the attachment process. Also, mono-, di- or tri-metal salts can be used as an agglomeration agent. Specific examples of the mono-valent metals include, but are not limited to, lithium, potassium and sodium. Specific examples of the divalent metals include, but are not limited to, calcium and magnesium. A specific example of the trivalent metals includes, but is not limited to, aluminum. Specific examples of anions that form the salts include, but are not limited to, chloride ion, bromide ion, iodine ion, carbonate ion and sulfate ion. In addition, attachment can be accelerated by heating. The particulates can be attached to the core particles at a temperature lower or higher than the glass transition temperature of the particulates. When the particulates are attached at a temperature around or lower than the glass transition temperature, agglomeration and/or adhesion of the particulates hardly occur in some cases. Therefore, it is preferred to heat the particulates thereafter to a higher temperature to accelerate agglomeration and/or adhesion and coverage of the core particles and make the surface of the shell portion uniform. The heating temperature and the heating time are suitably selected in terms of the adjustment of the uniformity of the surface and the sphericity of toner particles.

Elongation and/or Cross Linking Reaction

When a modified polyester resin having an isocyanate group at its end and an amine reactive therewith are added to introduce a modified polyester resin having a urethane and/or a urea linkage, the amine can be mixed in an oil phase before a toner component is dispersed in an aqueous medium or added to the aqueous medium. The reaction time is determined depending on the isocyanate group structure included in a polyester prepolymer and the reactivity thereof with the added amine and is typically from 1 minute to 40 hours and preferably from 1 to 24 hours. The reaction temperature is from 0 to 150° C. and preferably from 20 to 98° C. This reaction can be conducted before, during, or after the particulate attachment process described above. Any known catalyst can be used in the elongation reaction and/or cross linking reaction, if desired.

### Washing and Drying Process

Known technologies are used in the process of washing and drying toner particles dispersed in an aqueous medium. That is, after solid and liquid of an aqueous medium are separated by a centrifugal or a filter press to obtain a toner cake, the obtained cake is re-dispersed in de-ionized water at room temperature to about 40° C. Subsequent to optional pH adjustment by an acid or an alkali, the resultant is subject to the solid and liquid separation treatment again. This cycle is repeated several times to remove impurities and the active surface agent. Thereafter, the resultant is dried by an air stream drier, a circulation drier, a reduced pressure drier, a vibration flow drier, etc. to obtain toner powder. Toner particulate component can be removed by a centrifugal or a known classifier can be optionally used after drying to obtain toner having a desired particle size distribution.

### External Addition Treatment

The thus prepared toner mother particles after drying can be mixed with other particles such as the charge control agent particulates and fluidizing agent particulates. Such particles can be fixed on the toner particles by applying a mechanical impact thereto to integrate the particles into toner particles. Thus, the other particles can be prevented from being detached from the toner particles. Specific examples of such mechanical impact application methods include, but are not limited to, methods in which a mixture is mixed by a blade rotating at a high speed and methods in which a mixture is put into a jet air to collide the particles against each other or a collision plate.

Specific examples of such mechanical impact applicators include, but are not limited to, ONG MILL (manufactured by Hosokawa Micron Co., Ltd.), modified I TYPE MILL (manufactured by Nippon Pneumatic Mfg. Co., Ltd.) in which the pressure of pulverization air is reduced, HYBRIDIZATION SYSTEM (manufactured by Nara Machine Co., Ltd.), KRYPTRON SYSTEM (manufactured by Kawasaki Heavy Industries, Ltd.), automatic mortars, etc.

The toner of the present invention is colored particles formed of a binder resin, a coloring agent and a fixed surface protective agent to which an external additive is added. The product of the volume average particle diameter (μm) of the colored particle and the addition amount T (% by weight) of the external additive to the colored particle is preferably from 3 to 18. When the product is too small, the transferability of the toner tends to deteriorate and hollow defects may be observed in obtained images. Occurrence of this hollow defect is significant especially when a full color image is produced or a fixed surface protective agent is contained in toner particles. The transferability in this specification represents the degree of transfer easiness when a toner image formed on the surface of an image bearing member by development is transferred to a transfer medium. When a toner image on the surface of an image bearing member is temporarily transferred to an intermediate transfer body such as an intermediate transfer belt and thereafter the toner image on the intermediate transfer body is transferred to a transfer medium, the transferability means the degree of transfer easiness for both processes of transferring the toner image from the image bearing member to the intermediate transfer body to transfer medium. When the product is too large, the fixing property tends to deteriorate, which results in insufficient fixing strength of an obtained image.

There is no specific limit to the kind of the inorganic particulates as such external additives. Specific examples thereof include, but are not limited to, silica, titania, alumina, strontium titanate, tin oxides, and zinc oxide. These can be used alone or in combination. Silica is suitably used in terms of fluidity and chargeability. The inorganic particulates are preferably subject to a surface treatment by a known method using an agent including a typically used hydrophobizing agent such as a silane coupling agent, titanate coupling agent, silicone oil, and silicone varnish, a fluorinated silane coupling agent, a fluorinated silicone oil, coupling agents having an amino group or a quaternary ammonium salt group, and modified silicone oil.

### Process Cartridge

The development agent for use in the present invention can be used in an image forming apparatus having a process cartridge as illustrated in FIG. 4.

In the present invention, the process cartridge is formed of the image bearing member described above and at leat one optional devices described above, such as the charging device, the development device and the cleaning device, and structured to be detachably attachable to the main body of an image forming apparatus such as a photocopier and a printer.

The process cartridge illustrated in FIG. 4 has an image bearing member, a development device, a charging device, and a cleaning device. First, the image bearing member is rotationally driven at a predetermined circumference speed. The image bearing member is uniformly charged negatively or positively to a predetermined voltage at its surface by the charging device while in the rotation process. Then, the image bearing member is irradiated with slit irradiation or a laser beam scanning irradiation by an irradiation device according to obtained image information. Thus, a latent electrostatic image is formed on the surface of the image bearing member and developed with toner by the development device. The developed toner image is transferred to a transfer medium which is fed from a paper feeder to the portion between the image bearing member and the transfer device in synchronization with the rotation of the image bearing member. The transfer medium having the toner image thereon is separated from the surface of the image bearing member, introduced into the fixing device where the toner image is fixed on the transfer medium and then discharged outside as an output (a photocopy or a print). The surface of the image bearing member after the image transfer is cleared of residual toner remaining thereon by the cleaning device, discharged and then ready for the next image formation cycle.

### Measuring Method

### Particle Diameter

The method of measuring the particle size distribution of the toner particles is described next.

The particle size distribution of the toner particles can be measured by Coulter counter method, etc. For example, Coulter Counter TA-II and Coulter Multisizer II (both are manufactured by Beckman Coulter, Inc.) can be used as the measuring equipment. The measuring method is as follows:

First, add 0.1 to 5 ml of a surface active agent (preferably alkyl benzene sulfonate salt) as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; Add 2 to 20 mg of a measuring sample of solidified toner to the electrolytic aqueous solution; Conduct dispersion treatment for the electrolytic aqueous solution in which the measuring sample is dispersed for about 1 to 3 minutes by an ultrasonic dispersion device; Measure the volume and the number of the toner particles or the toner by the equipment mentioned above with an aperture of 100 μm; and calculate the volume distribution and the number distribution. The weight average particle diameter (Dv) and the number average particle diameter (Dn) of the toner can be obtained based on the obtained distributions.

The whole range is a particle diameter of from 2.00 to less than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to less than 40.30 μm.

An optical detection method can be used for measuring particle forms in which particle images are optically detected by a charge coupled device (CCD) camera while a suspension containing particles passes through an imaging detective portion having a plate form. The average circularity of the particle is determined by dividing the circumferential length of the circle having the area equal to a projected toner area with the circumferential length of the projected toner area. This value is a value measured by a flow type particle image analyzer FPIA-2100 as the average circularity. The specific procedure for obtaining the average circularity is as follows:
(1) A surface active agent serving as a dispersion agent, preferably 0.1 to 5 ml of an alkylbenzenesulfonic acid salt, is added to 100 to 150 ml of water from which solid impurities have been preliminarily removed;
(2) About 0.1 to 0.5 g of a sample to be measured is added into the mixture prepared in (1);
(3) The mixture prepared in (2) is subjected to an ultrasonic dispersion treatment for about 1 to 3 minutes such that the concentration of the particles is 3,000 to 10,000 particles per micro litter; and
(4) The form and average particle diameter distribution of the sample are measured by the instrument mentioned above.

### Glass Transition Temperature

The glass transition temperature (Tg) of the polyester resin and the vinyl based copolymer resin can be measured by using, for example, a differential scanning calorimeter (e.g., DSC-6220R, manufactured by Seiko Instruments Inc.) as follows: Heat a sample from room temperature to 150° C. at a temperature rise speed of 10° C./min; Leave the sample at 150° C. for 10 minutes; Cool down the sample at a temperature fall speed of 10° C./min; Heat the sample again from 20 to 150° C. at a temperature rise speed of 10° C./min; and obtain the glass transition temperature as the shoulder value between the base line below the glass transition temperature and the endothermic peak.

### Method of Measuring Softening Point (Tm)

Weigh 1.0 g of a sample using a flow tester (CFT-500, manufactured by Shimadzu Corporation) and measure the sample under the following conditions:
Die: height: 1.0 mm; Φ: 0.5 mm
Temperature rising speed: 3.0° C./min
Preliminary heating time: 180 seconds
Load: 30 Kg
Measuring temperature range: 60 to 160° C.

The softening point (Tm) is determined as the temperature when a half of the sample is effused.

### Particulate Diameter

The particle diameter of the vinyl based copolymer particulate can be measured using a dispersion body as it is by a measuring device such as LA-920 (manufactured by Horiba Ltd.) or UPA-EX150 (manufactured by Nikkiso Co., Ltd.).

Manufacturing Examples of the infrared absorbing agent are described below.

### Manufacturing Example of Infrared Absorbing Agent B (Indolenine Compound)

2.7 parts by weight of 4,5-benzo-1-(2-methoxyethyl)-3,3-dimethyl-2-methylene indoline and 0.8 parts by weight of 2-chloro-1-formyl-3-hydroxymethylene cyclohexane are boiled up in 4.0 parts by weight of acetic anhydride for one hour while cooled down with reflux and then cooled down to room temperature. The reaction liquid is suction-filtrated to remove undissolved impurities. The reaction liquid is infused to 4.0 parts by weight of water in which 0.5 parts of tetrafluoro sodium borate are dissolved and obtained dissipated crystal is suction-filtrated to recrystalize by 2.0 parts by weight of DMF. Subsequent to washing by 2.0 parts by weight of methanol and drying, 2.5 parts of the indolenine compound B represented by the following chemical structure (B). The maximum absorption wavelength of this [Infrared absorbing agent B] is 820 nm.

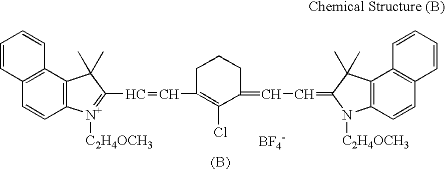

### Manufacturing Example of Infrared Absorbing Agent C (Aminium Compound)

1.38 g of N,N,N′,N′-tetrakis(p-dibutyl aminophenyl)-p-phenylnene diamine is dissolved in ethyl acetate and 6 ml of acetnitrile and a solution in which 0.22 g of sodium perchlorate and 1.13 g of ammonium salt of ferric complex salt of 1,3-diaminopropane tetraacetate are dissolved in 6ml of water are added. The resultant is stirred at 30° C. for 6 hours. The reaction mixture is washed by water and condensed under a reduced pressure and n-heptane is added thereto to precipitate a crystal. The precipitated crystal is filtered and dried to obtain green powder C of the infrared absorbing agent having the following Chemical structure (C). The maximum absorption wavelength of this [Infrared absorbing agent C] is 950 nm.

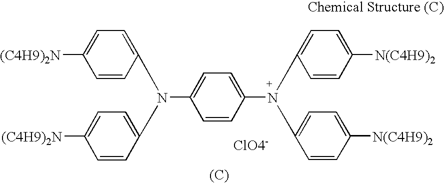

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis of Polyester

### Polyester 1

The following components are placed in a container equipped with a condenser, a stirrer and a nitrogen introducing tube to conduct a reaction at 230° C. at normal pressure for 8 hours followed by another reaction for 5 hours with a reduced pressure of 10 to 15 mmHg and 26 parts by weight of trimellitic anhydride is added to the reaction container to conduct a reaction at 180° C. at normal pressure for 2 hours to obtain [Polyester 1].

| | |
|---|---|
| Adduct of bisphenol A with 2 mole of ethylene oxide | 553 parts |
| Adduct of bisphenol A with 2 mole of propylene oxide | 196 parts |
| Terephthalic acid | 220 parts |
| Adipic acid | 45 parts |
| Dibutyl tin oxide | 2 parts |

[Polyester 1] has a number average molecular weight of 2,200, a weight average molecular weight of 5,600, a glass transition temperature of 43° C., and an acid value of 13 mgKOH/g.

### Synthesis of Vinyl Based Copolymer Resin Particulate

### Vinyl Based Copolymer Resin Particulate S-1

1.6 parts by weight of dodecyl sodium sulfate and 492 parts by weight of deionized water are placed in a reaction container equipped with a condenser, a stirrer and a nitrogen introducing tube and heated to 80° C. A solution in which 2.5 parts by weight of KPS (potassium peroxodisulfate) as a polymerization initiator is dissolved in 100 parts by weight of deionized water is added to the reaction container and 15 minutes later, a liquid mixture of a monomer composition of 152 parts by weight of styrene monomer, 38 parts by weight of butyl acrylate, 10 parts by weight of methacrylic acid and 3.5 parts by weight of NOM (n-octylmercaptan) as a molecular weight control agent is dripped to the reaction container in 90 minutes. Thereafter, the reaction system is maintained at 80° C. for 60 minutes. Subsequent to cooling down, a liquid dispersion of [Vinyl based copolymer resin particulate S-1] is obtained. The particle diameter of particulates is 50 nm. A small amount of the liquid dispersion is placed in a Petri dish and the solvent is evaporated to obtain a solid material. The solid material has a number average molecular weight of 11,000,a weight average molecular weight of 18,000, and a glass transition temperature of 65° C.

### Synthesis of Prepolymer

The following components are placed in a container equipped with a condenser, a stirrer and a nitrogen introducing tube to conduct a reaction at 230° C. at normal pressure for 8 hours followed by another reaction for 5 hours with a reduced pressure of 10 to 15 mmHg to synthesize [Intermediate polyester resin 1]:

| | |
|---|---|
| Adduct of bisphenol A with 2 mole of ethylene oxide | 682 parts |
| Adduct of bisphenol A with 2 mole of propylene oxide | 81 parts |
| Terephthalic acid | 283 parts |
| Trimellitic anhydride | 22 parts |
| Dibutyl tin oxide | 2 parts |

The obtained [Intermediate polyester resin 1] has a number average molecular weight of 2,100, a weight average molecular weight of 9,500, a glass transition temperature of 55° C., an acid value of 0.5 mgKOH/g and a hydroxyl value of 49 mgKOH/g.

Next, 411 parts of [Intermediate polyester 1], 89 parts of isophorone diisocyanate and 500 parts of ethyl acetate are placed in a reaction container equipped with a condenser, stirrer and a nitrogen introducing tube to conduct reaction at 100° C. for 5 hours to obtain [Prepolymer 1]. The weight % of isolated isocyanate of the obtained [Prepolymer 1] is 1.53%.

### Synthesis of Master Batch

40 parts of C.I. Solvent Red, 60 parts of binder resin (polyester resin) (RS-801, manufactured by Sanyo Chemical Industries, Ltd., Acid value: 10, Mw: 20,000, Tg: 64° C.) and 30 parts of water are mixed by a HENSCHEL MIXER to obtain a mixture in which water sops in a pigment agglomeration body. The mixture is mixed and kneaded for 45 minutes by two rolls where the temperature of the surface is set at 130° C. and pulverized by a pulverizer to the size of 1 mm Φ. Thus, [Master batch 1] is obtained.

### Example 1

### Preparation of Pigment, Wax and Infrared Absorbing Agent Liquid Dispersion (Oil Phase)

543.5 parts of [Polyester 1], 181 parts of paraffin wax (melting point: 72° C.), 6 parts of [Infrared absorbing agent B], 6 parts of [Infrared absorbing agent C] and 1,450 pars of ethyl acetate are placed in a reaction container equipped with a stirrer and a thermometer. After the system is heated to 80° C. while stirring, the system is maintained at 80° C. for 5 hours and then cooled down to 30° C. in one hour. Next, 500 parts of [Master batch 1] and 100 parts of ethyl acetate are placed in the reaction container followed by mixing for about one hour to obtain a [Raw material solution 1].

1,500 parts of [Raw material solution 1] is transferred to a vessel to disperse a pigment, the wax and the infrared absorbing agent using a bead mill (ULTRAVISCOMILL from AIMEX) under the following conditions:
Liquid feeding speed: 1 kg/hour
Disc rotation perimeter speed: 6 m/sec
Diameter of zirconia beads: 0.5 mm
Filling factor of zirconia beads: 80% by volume
Repeat number of dispersion treatment: 3 times

Next, 655 parts of 65% ethyl acetate solution of [Polyester 1] is added to the liquid dispersion. After 1 pass of the bead mill under the condition mentioned above, [Pigment, wax and infrared absorbing agent liquid dispersion 1] is obtained. Ethyl acetate added to [Pigment, wax and infrared absorbing agent liquid dispersion 1] to adjust the solid portion density thereof to be 50% (130° C., 30 minutes).

### Preparation of Aqueous Phase

968 parts of deionized water, 40 parts of 25% by weight aqueous liquid dispersion of organic resin particulates (a copolymer of styrene—methacrylic acid—butyl acrylate—a sodium salt of sulfate of an adduct of methacrylic acid with ethyleneoxide) for stabilizing dispersion, 150 parts of 48.5% aqueous solution of sodium dodecyldiphenyl etherdisulfonate (EREMINOR MON-7, manufactured by Sanyo Chemical Industries, Ltd.), and 98 parts of ethyl acetate are mixed and stirred. Thus, a milk white liquid of [Aqueous phase 1] is obtained.

### Emulsification

976 parts of [Pigment, wax and infrared absorbing agent liquid dispersion 1] and 2.6 parts of isophorone dimaine as an amine are mixed by a TK HOMOMIXER (manufactured by Tokushu Kika Kogyo Co., Ltd.) at a rotation number of 5,000 rpm for one minute. Thereafter, 88 parts of [Prepolymer 1] is admixed by the TK HOMOMIXER (manufactured by Tokushu Kika Kogyo Co., Ltd.) at a rotation number of 5,000 rpm for one minute. Then, 1,200 parts of [Aqueous phase 1] is added and the resultant is mixed by the TK HOMOMIXER (manufactured by Tokushu Kika Kogyo Co., Ltd.) for 20 minutes while controlling the rotation speed thereof in the range of from 8,000 to 13,000 rpm to obtain [Emulsified slurry 1].

### Removal of Solvent

[Emulsified slurry 1] is placed in a container equipped with a stirrer and a thermometer and the solvent is removed at 30° C. for 8 hours to obtain [Slurry dispersion 1].

### Particulate Attachment Process

Liquid dispersion of [Vinyl based copolymer resin particulate S-1] is added to [Slurry dispersion 1] with a ratio of 1 to 0.15 with regard to the solid portion and heated to 73° C. in 30 minutes time. A liquid in which 100 parts of hexahydrate of magnesium chlorinate is dissolved in 100 parts of deionized water is added to the resultant little by little while keeping the temperature at 73° C. After 4 hours, an aqueous solution of hydrochloric acid is added to the resultant to adjust pH thereof to be 5 followed by heating to 80° C. Subsequent to 2 hour cooling down, [Slurry dispersion 1-2] is obtained.

### Washing and Drying

After 100 parts of [Slurry dispersion 1-2] is filtered with a reduced pressure;
(I): 100 parts of deionized water is added to the filtered cake and the mixture is mixed by a TK HOMOMIXER at a rotation number of 12,000 rpm for 10 minutes;
(II): 900 parts of deionized water is added to the filtered cake of (I) and the resultant is mixed by a TK HOMOMIXER at a rotation number of 12,000 rpm for 30 minutes while applying ultrasonic vibration thereto, and then filtered under a reduced pressure. This operation is repeated until the electric conductivity of the re-slurry liquid is not greater than 10 μC/cm;
(III): 10% hydrochloric acid is added to the re-slurry liquid of (II) to make pH thereof to be 4 followed by 30 minute stirring by a three one motor; and
(IV): 100 parts of deionized water is added to the filtered cake of (III) and the resultant is mixed by a TK HOMOMIXER at a rotation number of 12,000 rpm for 10 minutes followed by filtration. This operation is repeated until the electric conductivity of the re-slurry liquid is not greater than 10 μC/cm. Thus, [Filtered cake 1] is obtained.

[Filtered cake 1] is dried by a circulating drier at 45° C. for 48 hours. The dried cake is sieved using a screen having an opening of 75 μm to obtain [Colored particle 1].

The obtained [Colored particle 1] is subject to external additive treatment as follows:

1.5 parts of hydrophobic silica (BET 200 m²/g) is admixed to 100 parts of [Colored particle 1] by HENSHCEL MIXER FM20C/I (manufactured by Mitsui Mining Co., Ltd.) for 5 minutes to obtain a toner (development agent).

With regard to HENSHCEL MIXER, a combination of upper wing AO and lower wing ST is used with a front speed of the lower wing is fixed at 40 m/s.

### Examples 2 to 8

The development agent of Example 2 is prepared in the same manner as in Example 1 except that, in preparation of [Pigment, wax and infrared absorbing agent liquid dispersion 1], the contents of paraffin wax (melting point 72° C.), [Infrared absorbing agent B] and [Infrared absorbing agent C] are changed to those shown in Tables 1-1 to 1-3 shown below.

### Comparative Example 1

450 parts of an aqueous solution of 0.1M Na₃PO₄ is set in 700 parts of deionized water and heated to 60° C. followed by stirring by CLEAREMIX CLS-30S (manufactured by M Technique Co., Ltd.) at 4,500 rpm. 68 parts of an aqueous solution of 0.1M CaCl₂ is added to the resultant little by little to obtain an aqueous medium containing a salt of calcium phosphate.

The following recipe is heated to 60° C. for uniform dissolution and dispersion.

| | | |
|---|---|---|
| Styrene | 160 | parts |
| n-butyl acrylate | 40 | parts |
| C.I. Pigment Blue 15:3 | 10 | parts |
| di-t-butyl salicylic acid metal compound | 2 | parts |
| Saturated polyester (Acid value: 15; Peak molecular weight: | 10 | parts |
| 12,000) | | |
| Ester-based wax (Melting point: 60° C.) | 30 | parts |
| Infrared absorbing agent B | 0.5 | parts |
| Infrared absorbing agent C | 0.5 | parts |
| Divinylbenzene | 0.3 | parts |

5 parts of 2,2′-azobis(2,4-dimethyl Valeronitrile) is dissolved in the resultant to prepare a polymeric monomer composition.

The polymeric monomer composition is set in the aqueous medium and stirred at 65° C. in nitrogen atmosphere by CLEARMIX at 4,500 rpm for 15 minutes to granulate another polymeric monomer composition.

Thereafter, the resultant polymeric monomer composition is heated to 70° C. and reacted for 12 hours while stirred by a puddle stirrer. After the polymerization reaction is complete, remaining monomer is removed at 80° C. under a reduced pressure. The resultant is cooled down and hydrochloric acid is added thereto to dissolve the salt of calcium phosphate. Thereafter, the resultant is filtered, washed with water and dried to obtain colored resin particles followed by the same external additive treatment as described in Example 1 to obtain a development agent. The colored resin particle has a weight average molecular weight (Mw) of 500,000.

### Comparative Example 2

The development agent of Comparative Example 2 is obtained in the same manner as in Comparative Example 1 except that the infrared absorbing agents B and C are not internally added but by impacted to the surface of the colored resin particle.

To be specific, after a colored resin particle to which infrared absorbing agents B and C are not added is obtained, the colored resin particle and the infrared absorbing agents B and C are mixed followed by a surface improvement treatment by a hybridization system (manufactured by Nara Machinery Co., Ltd.).

### Comparative Example 3

### Pulverization Method

### Manufacturing of Resin H

600 g of styrene, 110 g of butyl acrylate, and 30 g of acrylic acid as vinyl monomers and 30 g of dicumyl peroxide as a polymerization initiator are set in a dripping funnel. 1,230 g of polyoxypropylene (n=2.2)-2,2-bis (4 hydroxyphenyl)propane and 290 g of polyoxyethylene (n=2.2)-2,2-bis(4 hydroxyphenyl)propane as polyols, 250 g of an anhydride of isododecenyl succinic acid, 310 g of terephthalic acid, 180 g of an anhydride of 1,2,4-benzene tricarboxylic acid as polycarboxylic acids, 7 g of dibutyl tin oxide as an esterification catalyst, and 460 g of paraffin wax (melting point: 73.3° C.; half width value of endothermic peak measured during temperature rising by a differential scanning calorimeter: 3.9° C.) as a fixed surface protective agent are set in a flask equipped with a thermometer, a stainless stirrer, a flow type condenser, and a nitrogen introducing tube. The liquid mixture of the vinyl monomers and the polymerization initiator is dripped in nitrogen atmosphere from the dripping funnel in one hour time while stirred at 160° C. using a mantle heater. Addition-polymerization of the mixture is aged for 2 hours at 160° C. and heated to 230° C. to conduct a polycondensation reaction. Thereafter, the polymerization degree is traced by measuring the softening point T1/2 with a flow tester. When the temperature reaches a desired value, the reaction is made complete to obtain [Resin H]. [Resin H] has a softening point of 160° C.

### Manufacturing of Resin L

2,210 g of polyoxypropylene (n=2.2)-2,2-bis(4-hydroxyphenyl)propane as a polyol, 850 g of terephthalic acid and 120 g of an anhydride of 1,2,4-benzene tricarboxylic acid as polycarboxylic acids, and 0.5 g of dibutyl tin oxide as an esterification catalyst, are set in a flask equipped with a thermometer, a stainless stirrer, a flow type condenser, and a nitrogen introducing tube. The liquid mixture is heated in nitrogen atmosphere to 230° C. to conduct a polycondensation reaction. Thereafter, the polymerization degree is traced by measuring the softening point T1/2 with a flow tester. When the temperature reaches a desired value, the reaction is made complete to obtain [Resin L]. [Resin L] has a softening point of 120° C.

After mixing 30 parts of [Resin H], 70 parts of [Resin L], 1 part of a metal salt of a salicylic acid derivative as a charge controlling agent, 5 parts of C.I. Pigment Blue 15:3 as a coloring agent, 0.2 parts of [Infrared absorbing agent B] and 0.2 parts of [Infrared absorbing agent C] with a blender, the mixture is mixed and kneaded by a two-axis extruder and then cooled down. Subsequent to pulverization and classification, colored resin particles are obtained and the external additive is added thereto in the same manner as in described in Example 1 to obtain a development agent.

### Comparative Example 4

The development agent of Comparative Example 4 is obtained in the same manner as in Comparative Example 3 except that the addition method of the coloring agent is changed to a method using a master batch.

That is, the binder resin and the pigment are set in a pressure kneader with a weight ratio of 7 to 3 and mixed and kneaded at 120° C. for one hour. Subsequent to cooling down, the mixture is coarsely pulverized by a hammer mill to obtain a coloring agent master batch containing a coloring agent with a content ratio of 30% by weight. In addition, the addition amount of the coloring agent master batch is adjusted to make the content thereof the same as the content of the coloring agent contained in the development agent of Example 3. In addition, the total content of the resin in the development agent including the resin contained in the coloring agent master batch is adjusted to be the same to obtain a development agent having the same composition as that of Example 3.

### Comparative Example 5

### Manufacturing of Resin M

600 g of styrene, 110 g of butyl acrylate, and 30 g of acrylic acid as vinyl monomers and 30 g of dicumyl peroxide as a polymerization initiator are set in a dripping funnel. 1,230 g of polyoxypropylene (n=2.2)-2,2-bis(4-hydroxyphenyl)propane and 290 g of polyoxyethylene (n=2.2)-2,2-bis(4-hydroxyphenyl)propane as polyols, 250 g of an anhydride of isododecenyl succinic acid, 310 g of terephthalic acid, 180 g of an anhydride of 1,2,4-benzene tricarboxylic acid as polycarboxylic acids, and 7 g of dibutyl tin oxide as an esterification catalyst are set in a flask equipped with a thermometer, a stainless stirrer, a flow type condenser, and a nitrogen introducing tube. The liquid mixture of the vinyl monomers and the polymerization initiator is dripped in nitrogen atmosphere from the dripping funnel in one hour time while stirred at 160° C. using a mantle heater. The mixture is addition-polymerized, aged for 2 hours at 160° C. and heated to 230° C. to conduct a polycondensation reaction. Thereafter, the polymerization degree is traced by measuring the softening point T1/2 with a flow tester. When the temperature reaches a desired value, the reaction is made complete to obtain [Resin M]. [Resin M] has a softening point of 160° C.

After mixing 30 parts of [Resin M], 70 parts of [Resin L] prepared in Comparative Example 3, 1 part of a metal salt of a salicylic acid derivative as a charge controlling agent, 5 parts of C.I. Pigment Blue 15:3 as a coloring agent, 4 parts of paraffin wax, 0.2 parts of [Infrared absorbing agent B] and 0.2 parts of [Infrared absorbing agent C] with a blender, the mixture is mixed and kneaded by a two-axis extruder and then cooled down. Subsequent to pulverization and classification, colored resin particles are obtained and the external additive is added thereto in the same manner as in described in Example 1 to obtain a development agent.

The properties, the compositions and the structures of the toners obtained in Examples and Comparative Examples are shown in Table 1. The ratio around the fixed surface protective agent, the existing position and the surface exposure represent the ratio of the infrared absorbing agents existing around the fixed surface protective agent, the existing position of the infrared absorbing agents and the surface exposure of the infrared absorbing agent, respectively.

In addition, the evaluation results according to the following are shown in Table 2.

### Vertical Streak

A predetermined printed pattern having a print ratio of 6% is continuously printed for a run length of 2,000 sheets in the N/N environment (23° C. and 45%) using ipsio CX 2500 (manufactured by Ricoh Co. Ltd.). In addition, a solid image having a print ratio of 100% is continuously printed for a run length of 2,000 sheets in the same environment as mentioned above.
G (Good): No vertical streaks observed:
F (Fair) : Vertical streaks slightly observed but no uneven density:
B (Bad): Vertical streaks observed in at least one of the print patterns, which causes a practical problem.

### Uneven Density

A predetermined printed pattern having a print ratio of 6% is continuously printed for a run length of 2,000 sheets in the N/N environment (23° C. and 45%) using ipsio CX 2500 (manufactured by Ricoh Co. Ltd.). In addition, a solid image having a print ratio of 100% is continuously printed for a run length of 2,000 sheets in the same environment as mentioned above.
G (Good): No density unevenness observed
F (Fair): Density unevenness slightly observed but no practical problem
B (Bad): Density unevenness in at least one of the print patterns, which causes a practical problem.

### Fixing Property Evaluation

A single color non-fixed image is formed by using ipsio CX2500 (manufactured by Ricoh Co. Ltd.). The amount of toner attachment on the sheet is 2 g/m². This non-fixed image is fixed by a flash fixing device using a Xenon lamp having emission spectrum peaks in the oscillation wavelength range of from 810 to 840 nm and from 900 to 980 nm as a light source. The fixing power is 3.0 J/cm² and the transfer speed is 120 mm/sec.

The fixing property is evaluated by the variance in the image density before and after the fixed image is rubbed by a sand eraser. The variance in the image density is defined to be 100% when there is no change to the image density.
G (Good): Variance in image density is 80% or higher
F (Fair): No practical problem (variance in image density is 70% or higher)
B (Bad): Practical problem (variance in image density is less than 70%)

### Anti-Smear Property

The degree of contamination of unused paper when the unused paper is rubbed with the image obtained for the fixing property evaluation is observed and evaluated.
G (Good): No contamination observed
F (Fair): Contamination observed but no practical problem
B (Bad): Significant contamination observed, which causes a practical problem

### Color Reproducibility

A single color toner image is formed such that the amount of toner attachment is 5 g/m².
G (Good): Good color reproducibility
F (Fair) : Cloud slightly observed in color without causing a practical problem
B (Bad): Cloud significantly observed in color, which causes a practical problem

TABLE 1-1

| | Toner Properties | | | | |
|---|---|---|---|---|---|
| | Particle Diameter | | | Form | Tm |
| | Dt (μm) | Dn (μm) | Dt/Dn | Circularity | ° C. |
| Example 1 | 5.7 | 5.0 | 1.14 | 0.97 | 129 |
| Example 2 | 5.8 | 5.1 | 1.14 | 0.98 | 130 |
| Example 3 | 5.8 | 5.0 | 1.16 | 0.98 | 130 |
| Example 4 | 5.7 | 5.0 | 1.14 | 0.98 | 131 |
| Example 5 | 5.7 | 5.0 | 1.14 | 0.98 | 130 |
| Example 6 | 5.8 | 5.1 | 1.14 | 0.98 | 129 |
| Example 7 | 5.8 | 5.1 | 1.14 | 0.98 | 130 |
| Example 8 | 5.7 | 5.0 | 1.14 | 0.98 | 130 |
| Comparative | 7.5 | 6.4 | 1.17 | 0.97 | 130 |
| Example 1 | | | | | |
| Comparative | 7.6 | 6.5 | 1.17 | 0.97 | 131 |
| Example 2 | | | | | |
| Comparative | 6.8 | 5.7 | 1.19 | 0.94 | 129 |
| Example 3 | | | | | |
| Comparative | 6.8 | 5.6 | 1.21 | 0.94 | 129 |
| Example 4 | | | | | |
| Comparative | 6.9 | 5.7 | 1.21 | 0.94 | 129 |
| Example 5 | | | | | |

TABLE 1-2

| | Toner Composition and Structure | | |
|---|---|---|---|
| | Fixing surface | | |
| | protective | Infrared | Infrared |
| | agent A | absorbing agent B | absorbing agent C |
| | (% by weight) | (% by weight) | (% by weight) |
| Example 1 | 6.0 | 0.2 | 0.2 |
| Example 2 | 4.0 | 0.2 | 0.2 |
| Example 3 | 8.0 | 0.2 | 0.2 |
| Example 4 | 6.0 | 0.3 | 0.3 |
| Example 5 | 6.0 | 0.2 | 0.4 |
| Example 6 | 6.0 | 0.4 | 0.6 |
| Example 7 | 6.0 | 0.1 | 0.4 |
| Example 8 | 6.0 | — | 0.6 |
| Comparative | 11.0 | 0.2 | 0.2 |
| Example 1 | | | |
| Comparative | 11.0 | 0.2 | 0.2 |
| Example 2 | | | |
| Comparative | 4.0 | 0.2 | 0.2 |
| Example 3 | | | |
| Comparative | 4.0 | 0.2 | 0.2 |
| Example 4 | | | |
| Comparative | 4.0 | 0.2 | 0.2 |
| Example 5 | | | |

TABLE 1-3

| | Toner Composition and Structure | | |
|---|---|---|---|
| | Ratio around the | | |
| | fixed surface | | |
| | protective | Existing | Surface |
| | agent (%) | position | exposure |
| Example 1 | 75 | Close to Surface | No |
| Example 2 | 64 | Close to Surface | No |
| Example 3 | 82 | Close to Surface | No |
| Example 4 | 72 | Close to Surface | No |
| Example 5 | 73 | Close to Surface | No |
| Example 6 | 68 | Close to Surface | No |
| Example 7 | 77 | Close to Surface | No |
| Example 8 | 75 | Close to Surface | No |
| Comparative | 51 | Close to Center | No |
| Example 1 | | | |
| Comparative | 0 | Close to Surface | Yes |
| Example 2 | | | |
| Comparative | 45 | Evenly | Yes |
| Example 3 | | dispersed | |
| Comparative | 52 | Evenly | Yes |
| Example 4 | | dispersed | |
| Comparative | 43 | Evenly | Yes |
| Example 5 | | dispersed | |

TABLE 2

| | Evaluation result | | | | |
|---|---|---|---|---|---|
| | | Uneven density | | Anti- | Color |
| | Vertical | (Toner | Fixing | smear | repro- |
| | streak | followability) | property | property | ducibility |
| Example 1 | G | G | G | G | G |
| Example 2 | G | G | G | G | G |
| Example 3 | G | G | G | G | G |
| Example 4 | G | G | G | G | G |
| Example 5 | G | G | G | G | G |
| Example 6 | G | G | G | G | G |
| Example 7 | G | G | G | G | G |
| Example 8 | G | G | G | G | G |
| Comparative | G | G | B | B | G |
| Example 1 | | | | | |
| Comparative | B | B | B | B | G |
| Example 2 | | | | | |
| Comparative | B | B | B | B | G |
| Example 3 | | | | | |
| Comparative | B | B | B | B | G |
| Example 4 | | | | | |
| Comparative | B | B | B | B | G |
| Example 5 | | | | | |

This document claims priority and contains subject matter related to Japanese Patent Application No. 2008-012428, filed on Jan. 23, 2008, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a binder resin;
a coloring agent;
an infrared absorbing agent having at least a maximum absorption wavelength in a wavelength range of from 700 to 1,100 nm; and
a fixed surface protective agent,
wherein the infrared absorbing agent which exists in the vicinity of the fixed surface protective agent occupies at least 60% by area based on an entire area of the infrared absorbing agent for a cross section observation of the toner, and
wherein the infrared absorbing agent is present inside the toner closer to a surface of the toner than to a center area thereof.

2. The toner according to claim 1, wherein the binder resin comprises a polyester resin.

3. The toner according to claim 2, wherein the polyester resin has a glass transition temperature of 40° C. or higher.

4. The toner according to claim 1, wherein the fixed surface protective agent is at least one compound selected from the group consisting of paraffins, synthetic esters, polyolefins, carnauba wax, and rice wax and the toner comprises the fixed surface protective agent in an amount of from 3 to 30% by weight.

5. The toner according to claim 1, wherein the toner comprises the infrared absorbing agent in an amount of 0.01 to 2% by weight.

6. The toner according to claim 1, wherein at least two compounds having respective maximum absorption wavelengths are used as the infrared absorbing agent.

7. The toner according to claim 1, wherein the toner has an average circularity of 0.95 or higher.

8. An image formation method comprising:
charging an image bearing member configured to bear a latent electrostatic image on a surface thereof;
irradiating the surface of the image bearing member to form the latent electrostatic image;
developing the latent electrostatic image with a development agent comprising the toner of claim 1 to form a toner image;
transferring the toner image to a recording medium; and
fixing the toner image on the recording medium by a flash fixing mechanism.

9. The image formation method according to claim 8, wherein the flash fixing mechanism comprises a mechanism which smoothes a surface of the toner of the toner image fixed on the recording medium.

10. The image formation method according to claim 8, wherein a single component development mechanism is used in the process of developing the latent electrostatic image.

11. An image forming apparatus comprising:
an image bearing member configured to bear a latent electrostatic image thereon;
a charging device configured to charge a surface of the image bearing member;
an irradiation device configured to irradiate the surface of the image bearing member to form the latent electrostatic image;
a development device comprising a development unit accommodating a development agent comprising the toner of claim 1, the development device configured to develop the latent electrostatic image with the toner to form a toner image on the surface of the image bearing member;
a transfer device configured to transfer the toner image to a recording medium while contacting the surface of the image bearing member with the recording medium therebetween; and
a fixing device configured to flash-fix the toner image on the recording medium.

12. The image forming apparatus according to claim 11, wherein the fixing device comprises a mechanism which smoothes a surface of the toner of the toner image fixed on the recording medium.
